(19) United States
(12) Patent Application Publication
(10) Pub. No.: US 2026/0052537 A1
(43) Pub. Date: Feb. 19, 2026

(54) SYSTEMS AND METHODS FOR COVERAGE ENHANCEMENT IN NON-TERRESTRIAL NETWORK (NTN)

(71) Applicant: ZTE CORPORATION, Shenzhen (CN)

(72) Inventors: Junli LI, Shenzhen (CN); Nan ZHANG, Shenzhen (CN); Fangyu CUI, Shenzhen (CN); Yachao YIN, Shenzhen (CN); Ziyang LI, Shenzhen (CN)

(73) Assignee: ZTE CORPORATION, Shenzhen (CN)

(21) Appl. No.: 19/317,254

(22) Filed: Sep. 3, 2025

Related U.S. Application Data
(63) Continuation of application No. PCT/CN2023/086523, filed on Apr. 6, 2023.

(51) Int. Cl. H04W 72/21; H04B 17/318; H04L 5/00

(52) U.S. Cl. CPC H04W 72/21; H04B 17/328; H04L 5/0055

(57) ABSTRACT

Presented are systems and methods for coverage enhancement in non-terrestrial network (NTN). A wireless communication device (e.g., UE) may send a message for physical uplink control channel (PUCCH) repetition to a wireless communication node (e.g., BS). The PUCCH repetition can comprise repetition of at least one of: PUCCH for msg4 hybrid automatic repeat request acknowledgment (HARQ-ACK), or common PUCCH. The message can comprise at least one of: a request for PUCCH repetition, or a capability report for PUCCH repetition.

### CROSS-REFERENCE TO RELATED APPLICATION

This application claims the benefit of priority under 35 U.S.C. § 120 as a continuation of International Patent Application No. PCT/CN2023/086523, filed on Apr. 6, 2023, the disclosure of which is incorporated herein by reference in its entirety.

### TECHNICAL FIELD

The disclosure relates generally to wireless communications, including but not limited to systems and methods for coverage enhancement in non-terrestrial network (NTN).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., UE) can send/transmit/provide/signal/communicate a message for physical uplink control channel (PUCCH) repetition to a wireless communication node (e.g., base station (BS), gNB, and/or non-terrestrial device). PUCCH repetition can comprise repetition of at least one of: PUCCH for msg4 hybrid automatic repeat request acknowledgment (HARQ-ACK), and/or common PUCCH. The message can comprise at least one of: a request for PUCCH repetition, and/or a capability report for PUCCH repetition.

In some implementations, the wireless communication device can receive/obtain/acquire a system information block (SIB) signaling from the wireless communication node. The SIB signaling can comprise a first indication of at least one of: whether the wireless communication device is allowed to send the message for PUCCH repetition, and/or whether the wireless communication device is allowed to interpret a second indication in downlink control information (DCI) scheduling msg4 physical downlink shared channel (PDSCH) for PUCCH repetition. In some examples, the indication the DCI can refer to the dedicated bit-field or existing bit-field (e.g., RV, MCS) to indicate the information (e.g., number of allowed repetition number, duration of application) for PUCCH repetition.

In some implementations, the message can comprise a preamble of a msg1. The preamble can comprise at least one of: a first portion of the preamble to indicate msg3 repetition and PUCCH repetition; a second portion of the preamble to indicate msg3 repetition without PUCCH repetition; and/or a third portion of the preamble to indicate operation without msg3 repetition and PUCCH repetition. In some implementations, the wireless communication device can send the message for PUCCH repetition via a preamble to the wireless communication node, when a condition is satisfied. The condition can comprise at least one of: multiple repetition numbers are configured by system information block (SIB) signaling, a measured reference signal received power (RSRP) is lower than a configured threshold (e.g., the threshold may be configured by SIB, in some examples, the threshold can be dedicated for PUCCH repetition. In some examples, the configured threshold for msg3 repetition and/or msg1 selection and/or msg1 repetition may be reused. In some examples, one factor as delta value (or scaling factor) can be configured and the threshold may be jointly determined by the configured factor and the threshold for msg3 repetition, msg1 selection, and/or msg1 repetition), and/or the first indication indicates that the wireless communication device is allowed to send the message for PUCCH repetition.

In some implementations, the wireless communication device can receive a high layer signaling comprising a mask index from the wireless communication node. The wireless communication device can determine, according to the mask index, one or more available random access channel (RACH) occasions (ROs) in which to send the message for PUCCH repetition. In some implementations, the each synchronization signal block (SSB) may be associated with at least two ROs, and the first indication can indicate that the wireless communication device is allowed to send the message for PUCCH repetition.

In some implementations, the wireless communication device can determine one or more other ROs in which to send at least one message for a 4-step random access procedure according to the mask index. In some implementations, the wireless communication device can determine one or more additional ROs in which to send at least one message for a 2-step random access procedure according to the mask index.

In some implementations, the wireless communication device can send the message for PUCCH repetition to the wireless communication node via a msg3. In some implementations, the wireless communication device can send the message for PUCCH repetition to the wireless communication node via a logical channel identifier (LCID) field and/or a medium access control (MAC) subheader field of the msg3.

In some implementations, the wireless communication device can send the message for PUCCH repetition to the wireless communication node via a msg3, when a condition is satisfied. The condition can comprise at least one of: multiple repetition numbers are configured by system information block (SIB) signaling, a measured reference signal received power (RSRP) is lower than a configured threshold, and/or the first indication indicates that the wireless communication device is allowed to send the message for PUCCH repetition.

In some implementations, the wireless communication device can determine a repetition number for the PUCCH repetition, according to at least one of: the mask index, and/or the one or more available ROs in which to send the message for PUCCH repetition. In some implementations, the wireless communication device can determine a repetition number for the PUCCH repetition, according to the second indication in downlink control information (DCI) scheduling msg4 physical downlink shared channel (PDSCH).

In some implementations, the wireless communication device can determine the repetition number for the PUCCH repetition, according to the second indication in DCI scheduling msg4 PDSCH, when a condition is satisfied. The condition can comprise at least one of: the wireless communication device may receive a first indication indicating that the wireless communication device is allowed to interpret the second indication in DCI scheduling msg4 PDSCH for PUCCH repetition, multiple repetition numbers can be configured by system information block (SIB) signaling, the message for PUCCH repetition may be sent by the wireless communication device, and/or a measured reference signal received power (RSRP) can be lower than a configured threshold.

In some implementations, the wireless communication device can determine according to a third indication in DCI scheduling msg4 PDSCH or a higher layer signaling, at least one of: whether to perform frequency hopping for the PUCCH repetition, and/or a type of frequency hopping to perform for the PUCCH repetition. In some implementations, the wireless communication device can determine at least one of: whether to perform frequency hopping for the PUCCH repetition, and/or a type of frequency hopping to perform for the PUCCH repetition, according to at least one of: whether a repetition number is indicated via a DCI scheduling msg4 PDSCH; whether a bit field to indicate frequency hopping pattern is indicated via system information block (SIB) signaling; and/or whether PUCCH repetition is configured to perform demodulation reference signal (DMRS) bundling among repetitions.

In some implementations, the wireless communication device can determine a duration of application of PUCCH repetition according to the one of following: a duration that starts at a time of sending of the message, and ends at a time at which the wireless communication device receives a configuration for a dedicated PUCCH from the wireless communication node; a duration that starts at a time of sending the message for PUCCH repetition, and ends at a time at which the wireless communication device sends a next message for PUCCH repetition; a duration that starts at a time of sending of the message for PUCCH repetition and ends at a time at which the wireless communication device receives another second indication of an updated repetition number, in DCI scheduling msg4 PDSCH, from the wireless communication node; a duration that starts at a time of receiving the second indication in DCI scheduling msg4 PDSCH, and ends at a time at which the wireless communication device receives a configuration for a dedicated PUCCH from the wireless communication node; a duration that starts at a time of receiving the second indication in DCI scheduling msg4 PDSCH, and ends at a time at which the wireless communication device sends a next message for PUCCH repetition; and/or a duration that starts at a time of receiving the second indication in DCI scheduling msg4 PDSCH, and ends at a time at which the wireless communication device receives the another second indication of an updated repetition number, in DCI scheduling msg4 PDSCH, from the wireless communication node.

In some implementations, the repetition number of PUCCH carrying HARQ-ACK for msg4 can be used for various PUCCH determined by the common PUCCH resource configuration. In some implementations, the repetition number may be used until (or up to) the determination of the new repetition value (e.g., indicated by the wireless communication node and/or determined by wireless communication device).

In some implementations, determining the duration of application can comprise: the wireless communication device can receive a system information block (SIB) signaling or a fourth indication in DCI scheduling msg4 PDSCH from the wireless communication node. The signaling can comprise at least one of: a specific value of the duration of validity; and/or an index corresponding to the specific value of the duration of validity. In some implementations, the wireless communication device can start a timer for the duration of application, responsive to the sending of the message for PUCCH repetition; or the wireless communication device can start a timer for the duration of application, responsive to the receiving of the second indication in DCI scheduling msg4 PDSCH.

At least one aspect is directed to a system, method, apparatus, or a computer-readable medium of the following. A wireless communication node can receive a message for physical uplink control channel (PUCCH) repetition from a wireless communication device. The PUCCH repetition can comprise repetition of at least one of: PUCCH for msg4 hybrid automatic repeat request acknowledgment (HARQ-ACK), and/or common PUCCH. The message can comprise at least one of: a request for PUCCH repetition (e.g., request for repetition, request for repetition with the recommended value from the wireless communication device, request for repetition by following the indicated value if a single value is indicated by the wireless communication node, request for repetition according to the indication via DCI, in some examples, the indication via DCI can refer to the dedicated bit or existing bit-field to scheduling msg2 and/or msg4 PDSCH), and/or a capability report for PUCCH repetition (e.g., the capability can refer to the capability to support PUCCH repetition, the capability of the number of repetition for PUCCH repetition, the capability of supporting the dynamic indicated repetition number, in some examples, the dynamic indicated repetition number can refer to the indication via DCI).

The systems and methods presented herein include a novel approach for coverage enhancement in a non-terrestrial network (NTN). Specifically, the systems and methods presented herein discuss a novel solution for using a repetition technology to enhance the coverage performance for communication between the wireless communication device (e.g., UE) and the wireless communication node (e.g., BS, gNB, and/or non-terrestrial device). The systems and methods can provide a coverage enhancement method for random access channel (RACH). The systems and methods can provide a coverage enhancement method for physical uplink control channel (PUCCH). The systems and methods can provide a coverage enhancement method for RRCSetupComplete.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a non-terrestrial network (NTN), in accordance with some embodiments of the present disclosure;

FIG. 4 illustrates an example of a process diagram for random access channel (RACH) procedure, in accordance with some embodiments of the present disclosure;

FIG. 5 illustrates an example preamble segmentation for msg3 physical uplink shared channel (PUSCH) to request repetition, in accordance with some embodiments of the present disclosure;

FIG. 6 illustrates an example implementation for reusing the preamble of request msg3 repetition to request physical uplink control channel (PUCCH) repetition, in accordance with some embodiments of the present disclosure;

FIG. 7 illustrates an example implementation for jointly indicating msg3 and PUCCH repetition, in accordance with some embodiments of the present disclosure;

FIG. 8 illustrates an example of a first random access channel (RACH) occasion (RO) allocation pattern with a physical random access channel (PRACH) mask index of two, in accordance with some embodiments of the present disclosure;

FIG. 9 illustrates an example of a second RO allocation pattern with a PRACH mask index of three, in accordance with some embodiments of the present disclosure;

FIG. 10 illustrates an example of a RO allocation pattern with a PRACH mask index of 10, in accordance with some embodiments of the present disclosure;

FIG. 11 illustrates another example of the first RO allocation pattern with a PRACH mask index of two, in accordance with some embodiments of the present disclosure;

FIG. 12 illustrates another example of the second RO allocation pattern with a PRACH mask index of two, in accordance with some embodiments of the present disclosure;

FIG. 13 illustrates an example of the first RO allocation pattern with a PRACH mask index of seven, in accordance with some embodiments of the present disclosure;

FIG. 14 illustrates an example of an RO allocation pattern with a PRACH mask index of seven, in accordance with some embodiments of the present disclosure;

FIG. 15 illustrates an example of an RO allocation pattern with a PRACH mask index of nine, in accordance with some embodiments of the present disclosure;

FIG. 16 illustrates a flow diagram of an example method for coverage enhancement in NTN, in accordance with an embodiment of the present disclosure.

### DETAILED DESCRIPTION

### 1. Mobile Communication Technology and Environment

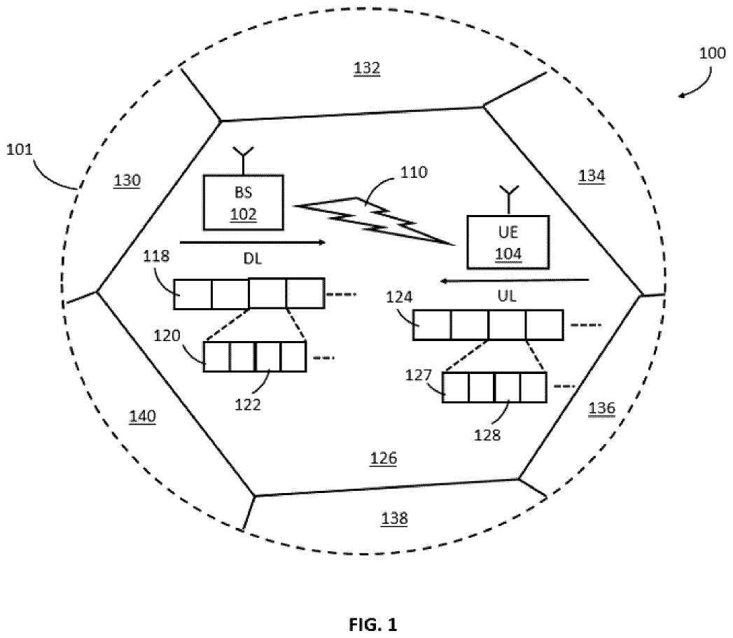

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

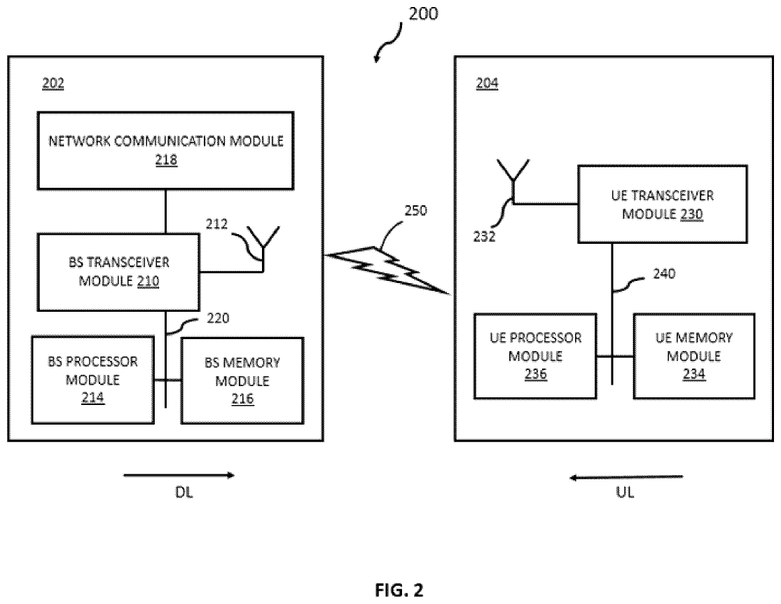

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Coverage Enhancement in Non-Terrestrial Network (NTN)

In a certain NTN, it may be desired to increase/enhance/improve network coverage performance to satisfy/meet the desired user experience rates and cell edge rates (or requirements for coverage performance). For instance, in a certain NTN, there may be a coverage bottleneck in physical uplink control channel (PUCCH) for msg4 hybrid automatic repeat request (HARQ)-acknowledgment (ACK) channel. To enhance the coverage performance of this channel (e.g., PUCCH), repetition technologies can be used/utilized. In msg3 physical uplink shared channel (PUSCH) repetition, the separate physical random access channel (PRACH) preamble (e.g., Msg1) may be used for requesting msg3 repetition. The enhancement of PRACH repetition may be implemented for various systems discussed herein. In some implementations, the PRACH preamble and/or occasion and/or msg3-based configurations can be used for PUCCH for msg4 HARQ-ACK repetition.

However, it may be difficult to manage/handle/address the relationship between PUCCH repetition, msg3 repetition, and/or PRACH repetition, in addition to avoiding/mitigating fragmentation of PRACH resources. Further, it may be desired to consider performing or initiating the request based on msg3 approach/method, the indication of the repetition number, and/or frequency hopping methods that support the repetition. Hence, the systems and methods of the technical solution discussed herein can provide an indication method for triggering PUCCH repetition requests and/or capability reports, repetition number indication, and/or frequency hopping indication, among other related signalings. In certain implementations, the payload size of RRCSetupComplete can be configured to one or more predetermined sizes (e.g., bits), such as approximately/around 984 bits (e.g., greater/larger than the payload size of msg3). In certain systems, the PUSCH scheduled by downlink control information (DCI) format 0_0 with cyclic redundancy check (CRC) scrambled by cell radio network temporary identifier (C-RNTI) may not support transmission repetition. As such, the systems and methods of the technical solution discussed herein can provide an enhancement for RRCSetupComplete repetition to support transmission repetition.

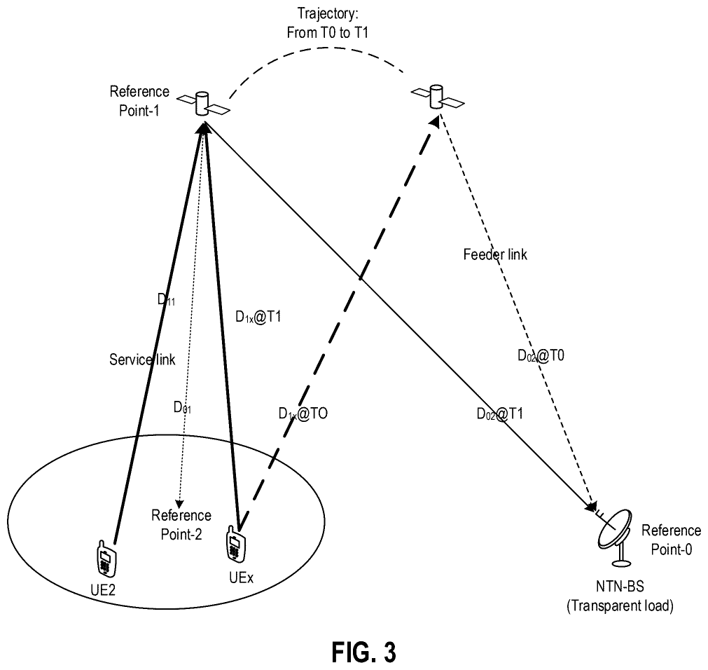

FIG. 3 illustrates an example structure of a transparent NTN, in accordance with some embodiments of the present disclosure. A link between a UE (e.g., a user equipment, the UE 104, the UE 204, a mobile device, a wireless communication device, a terminal, etc.) and a satellite can be a service link. A link between a BS (e.g., a base station, the BS 102, the BS 202, a gNB, an eNB, a wireless communication node, etc.) and a satellite can be a feeder link and can be common for all UEs within the same cell. To improve/enhance the coverage performance for the UE 104 in NTN, the systems and methods of the technical solution can perform various coverage enhancements methods/techniques discussed herein for at least one of RACH, PUCCH, and/or RRCSetupComplete.

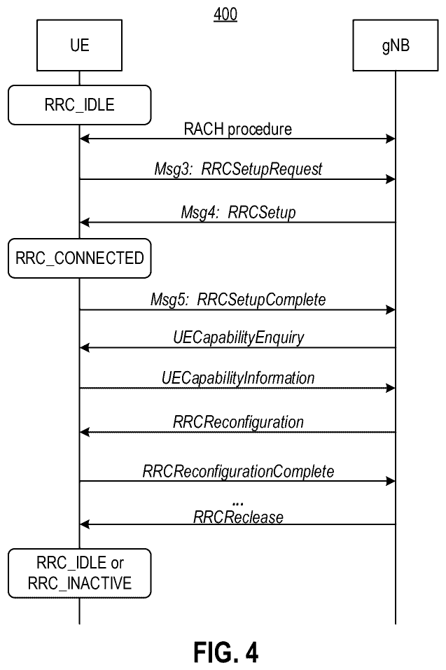

FIG. 4 illustrates an example of a process diagram 400 for RACH procedure, in accordance with some embodiments of the present disclosure. The process diagram 400 for the RACH procedure can include at least the following steps:
1) The UE 104 can transmit/send/provide/communicate the PRACH preamble if various conditions for PRACH transmission are satisfied/met.
2) The BS 102 (e.g., gNB, wireless communication network, and/or non-terrestrial device) may send a DCI scrambled with RA-RNTI value. The UE 104 can initiate a detection for (e.g., attempt/try to detect) a PDCCH (e.g., DCI) with the corresponding RA-RNTI within the period of random access response (RAR)-window. If the UE 104 successfully decoded the PDCCH, the UE 104 can decode the PDSCH carrying the RAR data. After decoding RAR, the UE 104 can check, identify, or determine if random access preamble identifier (RAPID) in RAR matches (e.g., is the same as) the RAPID assigned to the UE 104.
3) The UE 104 can transmit msg3 PUSCH (e.g., RRCSetupRequest) on the same serving cell to which the UE 104 (e.g., previously) sent PRACH, such as the serving cell the UE 104 transmits to in step 1. In various implementations, the UE 104 can transmit the msg3 PUSCH in response to the RAPID in RAR matches the RAPID assigned to the UE 104.
4) The UE 104 can monitor the PDCCH to decode control information associated with the UE 104 with (or using) temporary cell (TC)-RNTI. If the PDCCH is successfully decoded, the UE 104 can perform a decoding of PDSCH carrying the media access control (MAC) control element (CE), and/or set C-RNTI to TC-RNTI.
5) Responsive to the UE 104 successfully decoding the msg4 (e.g., contention resolution), the UE 104 can send a HARQ-ACK to the BS 102 for the data (e.g., PDSCH carrying msg4).
6) In some implementations, when the UE 104 is resuming or re-establishing an RRC connection, and the BS 102 is not able to retrieve/receive/obtain/acquire or verify/confirm the context of the UE 104 (e.g., set of information related to the UE 104), the UE 104 may receive an RRCSetup (e.g., msg4). In such cases, the UE 104 may respond/replay/communicate/transmit to the BS 102 with RRCSetupComplete (e.g., msg5).

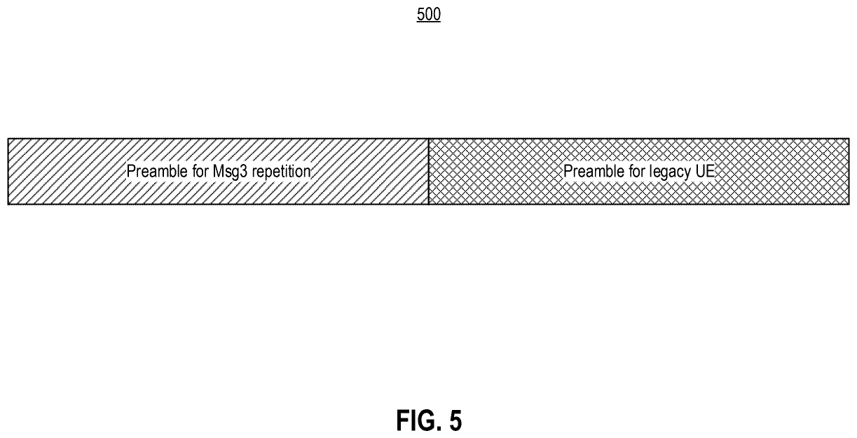

Referring to FIG. 5, depicted is an example preamble segmentation 500 for msg3 physical uplink shared channel (PUSCH) to request repetition. In certain systems for coverage enhancement, to request msg3 PUSCH repetition, the UEs 104 may use separate PRACH preambles in a shared RACH occasion, such as shown in FIG. 5. Since a PRACH occasion may include/comprise 64 preambles, one or more of these preambles may be used for contention-free random access. When the configured high layer parameter ssb-perRACH-OccupationAndCB-PreamlesPerSSB is greater than 1, a PRACH occasion may be associated with multiple synchronization signal blocks (SSBs), which may divide/separate/split the preambles. In such systems, there may be a conflict in/with Msg1, such as when dividing the preamble used for contention-free random access, for example.

### Example Implementation 1: Validity Duration of Request and/or Capability Indication for PUCCH Repetition

In some implementations, the BS 102 (or network) may configure a timing for when dedicated PUCCH configuration is to be provided by the UE 104, such as based on the configuration or implementation of the BS 102. In some cases, the msg4 PDSCH can include the configuration for when a dedicated PUCCH configuration is to be provided. In such cases, the BS 102 may determine whether to configure the dedicated PUCCH resource in the msg4 PDSCH according to its configuration. However, even after the HARQ for msg4, common PUCCH may still be reused in certain cases, e.g., the HARQ feedback for subsequent PDSCHs after successful random access may be carried by or included in the common PUCCH. To address such cases, for instance, to request transmission repetition or report capability indication (e.g., request/capability), additional criteria/restrictions/parameters may be introduced/provided/indicated to set, define, or configure the validity duration of the request/capability.

In various implementations, the validity duration can be configured/established/determined for requesting transmission repetition and/or reporting the repetition capability (e.g., repetition indication) of the UE 104. In some configurations, the UE 104 can implicitly determine or identify the validity duration (e.g., implicitly configured) via at least one of the following:
1) The validity duration of request (e.g., repetition request)/capability indication/report may be valid until/till the configuration or application of dedicated PUCCH (e.g., when the BS 102 allocated dedicated PUCCH resources after RACH procedure). For example, the validity duration can include, correspond to, or be a duration that starts at the time of the UE 104 sending of a message (e.g., the UE request/capability report of the random access process), and up to (e.g., ends at) a time at which the UE 104 receives/obtains/acquires a configuration for (e.g., or is configured with) the dedicated PUCCH from the BS 102.
2) The validity duration of request/capability indication may be valid until the UE capability report (e.g., the reporting of the UE capability or the transmission of the request for repetition). For example, the validity duration can include or correspond to a duration that starts at a time of sending the message (e.g., UE capability and/or repetition request) for PUCCH repetition, such as during the previous random access process, and ends at a time at which the UE 104 sends/indicates/provides the next (e.g., second) message (e.g., another capability reporting) for PUCCH repetition, such as during the current random access process.
3) The validity duration of request/capability indication may be valid until the updated/new configuration is broadcasted/signaled/provided from the BS 102 on the repetition number. For example, the validity duration can include or correspond to a duration that starts at a time of the UE 104 receives or when the BS 102 sends (e.g., in DCI scheduling msg4 PDSCH) an indication of the (e.g., previous) repetition number configured by the BS 102, and ends at a time at which the UE 104 receives or the BS 102 sends another indication of an updated/new repetition number (e.g., reconfigured or current repetition number), such as in DCI scheduling msg4 PDSCH.
4) The validity duration of request/capability indication may correspond to or include a duration that starts at a time of the UE 104 sending the message for PUCCH repetition (e.g., transmission repetition request or capability reporting) and ends at a time at which the UE 104 receives a configuration for a dedicated PUCCH from the BS 102.
5) The validity duration of request/capability indication may correspond to or include a duration that starts at a time of the UE 104 sending of the message for PUCCH repetition and ends at a time at which the UE 104 receives another indication (e.g., second indication) of an updated repetition number, such as in DCI scheduling msg4 PDSCH, from the BS 102.
6) The validity duration of request/capability indication may correspond to or include a duration that starts at a time of the UE 104 receiving the indication (e.g., of the repetition number) in DCI scheduling msg4 PDSCH, and ends at a time at which the UE 104 sends a next message for PUCCH repetition, for example.

In some other configurations, the validity duration(s) may be explicitly provided/signaled via a system information block (SIB) broadcast. For example, the UE 104 can receive the SIB signaling (e.g., fourth indication) in DCI scheduling msg4 PDSCH from the BS 102. The signaling can include an indication of a duration of validity. The validity duration can be configured as at least one of the following:
1) The validity duration can be a predetermined/predefined/specific value of the duration of validity. The predetermined value can indicate a duration that is sufficient to indicate (e.g., send the repetition request or report capability) until (e.g., in which ends when) the dedicated PUCCH is configured.
2) The validity duration(s) can be an index. Different index values correspond to different validity durations. In some cases, each index can correspond to a respective specific value of the validity duration. For example, index value 1 can correspond to a 2 second(s) validity duration, index value 2 can correspond to a validity duration of 10 s, etc. The minimum validity duration can be sufficient in length to indicate (e.g., send request/capability) until the dedicated PUCCH is configured.

In some implementations, for the validity duration of the request/capability, at least one of the following may be considered:
1) When the validity duration (e.g., the specific value indicative of the duration of validity) is configured via the SIB signaling from the BS 102, the UE 104 can start a timer for the duration of application (e.g., validity duration for request/capability report), such as timing/counting responsive to or after the UE 104 send the message for PUCCH repetition (e.g., the request/capability reporting). During the validity duration, the request/capability indication can remain valid, such that the UE 104 can perform the request/capability indication. If the validity duration expires (e.g., timer expiration) and the UE 104 has not successfully completed the random access procedure, the UE 104 can reattempt/reiterate sending the request/capability report. In response to another attempt at the request/capability report, the UE 104 can restart/reset/reinitiate the timer.
2) The UE 104 may start or restart the timer for the duration of application in response to the UE 104 receiving the indication in DCI scheduling msg4 PDSCH. In this case, the indication can indicate the (e.g., updated) repetition number, for example.

In various implementations discussed herein, through/via SIB signalings, the BS 102 can broadcast/indicate/send at least one enabling signal to the UE 104. The enabling signal can indicate whether the UE 104 is allowed/permitted (or blocked) to request the PUCCH repetition for msg4 HARQ-ACK, and/or whether the UE 104 is allowed to interpret the indication in DCI scheduling msg4 PDSCH for PUCCH repetition, as discussed herein. For example, the enabling signaling can include pucchRequestRepEnable, which may include one or more bits. Based on the bit (e.g., ‘1’ or ‘0’, depending on the configuration), the UE 104 can determine whether it is allowed to request the PUCCH repetition and/or interpret the indication in DCI scheduling msg4 PDSCH for PUCCH repetition, for example. The UE 104 can measure the SSB, and/or other signals sent by the BS 102. Subsequently, the UE 104 can determine (e.g., calculate/compute) whether to indicate repetition request or report capability according to the measured SSB.

### Example Implementation 2: PUCCH Repetition Request/Capability Report Using/Through Preamble

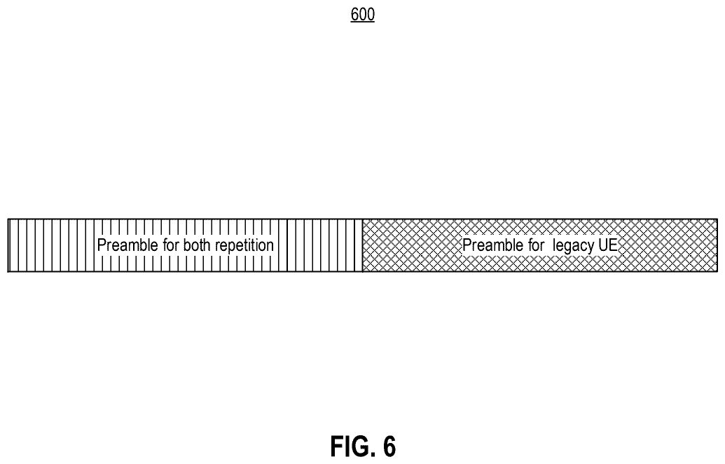

Referring to FIG. 6, depicted is an example implementation 600 for reusing the preamble of request msg3 repetition to request PUCCH repetition, in accordance with some embodiments of the present disclosure. In some cases, when only reusing the preamble of request msg3 repetition to request PUCCH repetition, the preamble can be separated or fragmented, such as shown in FIG. 6. However, because the performance (e.g., resources) of PUCCH for msg4 HARQ-ACK may be relatively greater than that of msg3 signals, in certain situations, the msg3 repetition may be desired, such as without the PUCCH repetition. In this example, if the configuration in FIG. 6 is used, there may be unnecessary PUCCH repetitions, thereby leading to access delay and/or wasted/excessive consumption of the network resources (e.g., (e.g., time-frequency resources). In such case, BS 102 (or the network) may have or provide a separate preamble (e.g., one of the 64 preambles for each UE 104) for PUCCH for msg4 HARQ-ACK to trigger PUCCH repetition via at least one of the following configurations.

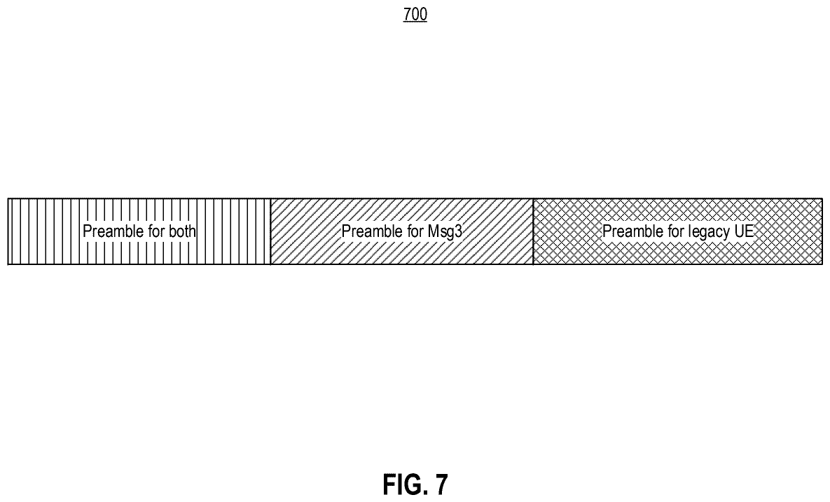

For example, the UE 104 can (e.g., jointly) indicate or send the message including a preamble of a msg1 to request repetition or report repetition capability for both channels, and separate preamble for PUCCH. Referring to FIG. 7, depicted is an example implementation 700 for jointly indicating msg3 and PUCCH repetition, in accordance with some embodiments of the present disclosure. As shown in FIG. 7, there is a joint indication mechanism or technique of repetition request for these two channels. The preamble configured for msg3 repetition may request for repetition of PUCCH for msg4 HARQ-ACK. In some cases, when the PUCCH repetition is not required, msg3 may be configured for repetition. To satisfy these configurations for different repetitions, one or more preambles can be configured for msg3. For example, the preamble of the msg1 can include at least one of a first portion, a second portion, and/or a third portion of the preamble. The first portion of the preamble can indicate msg3 repetition and PUCCH repetition. The second portion of the preamble can indicate msg3 repetition without PUCCH repetition. The third portion of the preamble can indicate an operation without msg3 repetition and PUCCH repetition.

### Example Implementation 3: PUCCH Repetition Request/Capability Report Via ROS

In certain implementations, an indication of PUCCH repetition capability via the PRACH preamble may result in the segmentation of the PRACH preambles, which may increase the likelihood of a collision, for instance, because relatively large preamble fragmentation may have existed for supporting certain features, such as redCap, slicing, service data transport (SDT), etc., and relatively large cell sizes in NTN. The collision may refer to a conflict that may occur because of the multiple segments or fragments of the preamble. For example, when there are multiple segments, different segments may be applied to different scenarios, and the number of preambles contained within the same segment may decrease. When multiple UEs select at least one preamble within the same segment to trigger the corresponding requests, the probability of selecting the same preamble to send the requests can increase, thereby resulting in a potential conflict or collision. Further, PRACH repetition may consume relatively greater resources in certain systems. To avoid the collision and minimize/decrease resource consumption, the BS 102 and/or the UE 104 can use at least one separate RACH occasion (RO) with a shared preamble for PUCCH to trigger repetition via at least one of the following configurations. In various implementations, the UE 104 can provide the PUCCH repetition request/capability report via the RO, where each RO can include all (or shared) preambles, such that there are no preamble fragments using the RO for repetition request/capability report.

### Example 1 of Example Implementation 3

In some configurations, a high layer signaling pucchRequestRep-SSB-SharedRO-MaskIndex (e.g., PRACH mask index) may be defined/configured for indexing ROs that are (e.g., currently) available for PUCCH repetition. The high layer signaling may be configured, for instance, when ssb-perRACH-OccasionAndCB-PreamlesPerSSB<1. The mask index can occupy 4 bits, indicating the subset of 4-step type ROs shared with requesting PUCCH repetition for each SSB. This field (e.g., the 4 bits occupied by the high layer signaling) can be configured when there are more than one ROs per SSB (e.g., each SSB may be associated with at least two ROs). The high layer signaling can include, correspond to, or be a part of at least one of SIB signaling, RRC signaling, MAC CE signaling, etc. For example, the UE 104 can receive/obtain the high layer signaling from the BS 102, where the high layer signaling can include a mask index. The UE 104 can determine, according to the mask index, one or more available ROs in which to send the message for PUCCH repetition (e.g., transmission repetition/capability reporting).

In some cases, if the pucchRequestRepEnable (e.g., first indication) is absent (e.g., not included), the UE 104 may use the configured ROs for the 4-step RACH (e.g., may not use the ROs to request PUCCH repetition). If the pucchRequestRepEnable (e.g., first indication) is present, in this case, partial RO sharing may be supported, such that ROs within the subset may be shared for performing PUCCH repetition requests/capability reports, and ROs outside the subset may be used for non-PUCCH repeat regular UEs 104 (e.g., one or more other UEs 104 that may not perform or may not be required to perform PUCCH repetition). Further, the high-level signaling pucchRequestRepEnable (e.g., such as defined herein) may indicate whether the UE 104 can request PUCCH repetition on the configured RO. For example, when pucchRequestRepEnable (e.g., first indication) is enabled/activated/active (e.g., indication of the pucchRequestRepEnable being utilized for the indications), the pucchRequestRepEnable can indicate that all currently configured ROs can use the corresponding ROs of the PRACH mask index to request the PUCCH repetitions. In this case, the UE 104 can be allowed to send the message for PUCCH repetition according to the first indication, for example. When the pucchRequestRepEnable value is disabled/inactive/deactivated (e.g., indication of pucchRequestRepEnable not being utilized for the indications), the pucchRequestRepEnable (or disabling of pucchRequestRepEnable) can indicate that all currently configured ROs are not available for requesting PUCCH repetitions, such that the configured (e.g., other) ROs are used for 4-step random access. In this case, according to the mask index, the UE 104 can determine one or more other ROs in which to send at least one message for the 4-step random access procedure. The high layer signaling can indicate/provide the relationship between PUCCH repetition number and ROs through/via the configuration of Table 1.

| PRACH Mask Index/pucchRepRequest- | Allowed PRACH |
|---|---|
| SSB-SharedRO-MaskIndex | occasion(s) of SSB |
| 0 | Reserved |
| 1 | RO 1 |
| 2 | RO 2 |
| 3 | RO 3 |
| 4 | RO 4 |
| 5 | RO 5 |
| 6 | RO 6 |
| 7 | RO 7 |
| 8 | RO 8 |
| 9 | Every even RO# |
| 10 | Every odd RO# |
| 11 | Reserved |
| 12 | Reserved |
| 13 | Reserved |
| 14 | Reserved |
| 15 | Reserved |

### Example Table 1: PRACH Mask Index Values for PUCCH Repetition Request

### Example 1a of Example Implementation 3

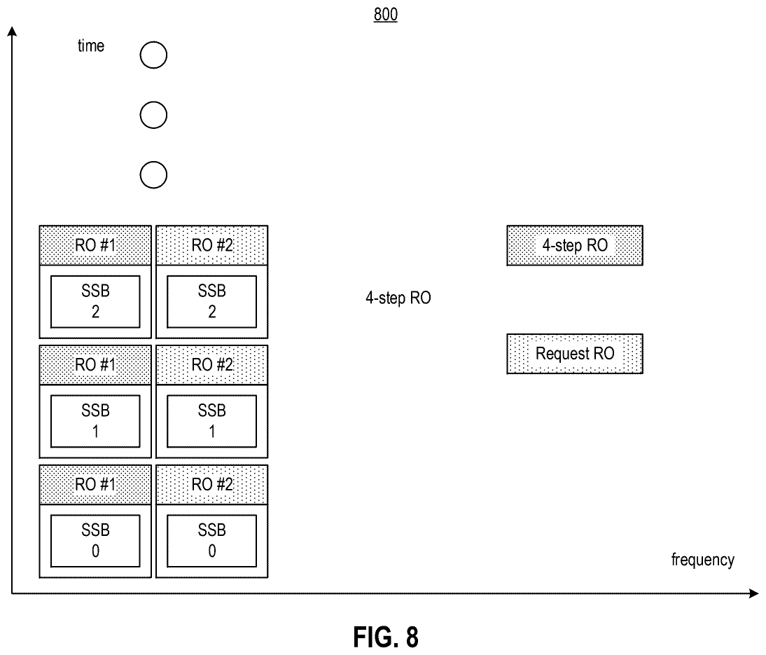

Referring to FIG. 8, depicted is an example 800 of a first RO allocation pattern (e.g., RO allocation pattern 1) with a PRACH mask index of two, in accordance with some embodiments of the present disclosure. In some implementations, when pucchRequestRepEnable=1, PRACH mask index=2, ssb-perRACH-OccasionAndCB-PreamlesPerSSB=½, and msg1-FDM (e.g., number of frequency domains of a time domain associated with a respective SSB)=2, the high layer signaling can indicate that one SSB is associated with two ROs (e.g., frequency domain), two frequency domain ROs (e.g., RO #1 and RO #2) on the first time domain RO correspond to one SSB (e.g., a first SSB), and two frequency domain ROs on the second time domain RO correspond to another SSB (e.g., a second SSB), etc. In such a configuration, according to or based on the allowed PRACH occasion(s) of SSB PRACH occasion index 2, the RO used for PUCCH repetition can be RO #2. The mapping relationship between the ROs and the SSBs used for PUCCH repetition can be represented/depicted/illustrated in FIG. 8, for example. In this case, the criteria can include multiple ROs mapped to a respective SSB (e.g., two ROs in SSB0, SSB1, SSB2, etc.).

### Example 1b of Example Implementation 3

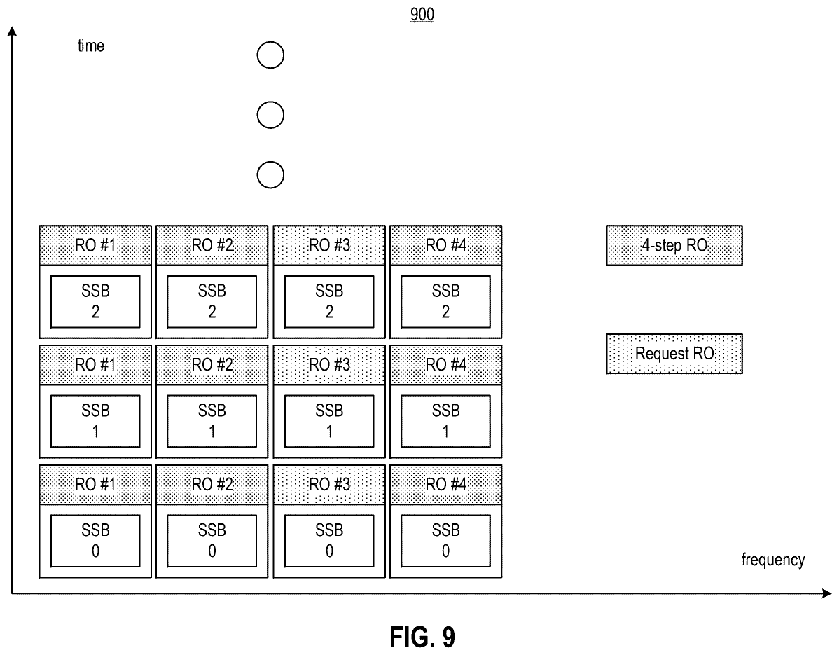

Referring to FIG. 9, depicted is an example 900 of a second RO allocation pattern (e.g., RO allocation pattern 2) with a PRACH mask index of three, in accordance with some embodiments of the present disclosure. In some implementations, when pucchRequestRepEnable=1 (e.g., bit set to ‘1’), PRACH mask index=3, ssb-perRACH-OccasionAndCB-PreamlesPerSSB=¼, and msg1-FDM=4, the high layer signaling can indicate that an SSB is associated with four ROs (e.g., frequency domain). The four frequency domain ROs on the first time domain RO can correspond to or be associated with one respective SSB (e.g., a first SSB), the four frequency domain ROs on the second time domain RO correspond to another SSB (e.g., a second SSB), etc. In such configurations, according to the allowed PRACH occasion(s) of SSB PRACH occasion index 3, the RO used for the PUCCH repetition (e.g., replication) request can be RO #3. The mapping relationship between these ROs and SSBs for PUCCH can be shown in FIG. 9, for example.

### Example 1c of Example Implementation 3

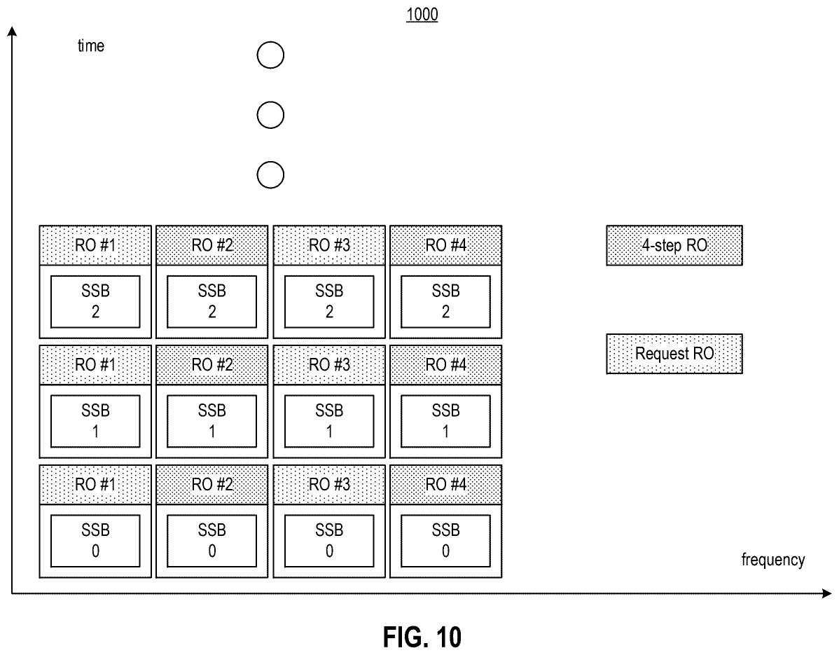

Referring to FIG. 10, depicted is an example 1000 of a RO allocation pattern with a PRACH mask index of 10. In some implementations, when pucchRequestRepEnable=1, PRACH Mask Index=10, ssb-perRACH-OccasionAndCB-PreamlesPerSSB=¼, and msg1-FDM=4, the high layer signaling can indicate that an SSB is associated with four ROs (e.g., frequency domain). The four frequency domain ROs on the first time domain RO can correspond to one SSB, the four frequency domain ROs on the second time domain RO correspond to another SSB, etc. In such configurations, according to the allowed PRACH occasion(s) of SSB PRACH occasion index 10, the ROs used for the PUCCH repetition request can include or correspond to RO #1 and RO #3 (e.g., odd-numbered RO). The mapping relationship between the ROs and the SSBs can be shown in FIG. 10, for example.

### Example 2 of Example Implementation 3

In various implementations, a high layer signaling pucchRequestRep-SSB-SharedRO-MaskIndex (e.g., PRACH mask index) may be defined/set/configured for indexing ROs currently available for PUCCH repetition. The high layer signaling may be configured, for instance, when ssb-perRACH-OccasionAndCB-PreamlesPerSSB<½ (e.g., 0.5). The mask index can occupy 4 bits, indicating the subset of a subset of 4-step type ROs shared with requesting PUCCH repetition for each SSB. This field of the high layer signaling may be configured when there are more than two ROs per SSB.

If the pucchRequestRepEnable is absent (e.g., does not exist or not presented), the 4-step and/or the 2-step may have shared ROs. If the pucchRequestRepEnable is present, in this case, partial RO sharing may be supported. The ROs within the subset can be shared with PUCCH for repetition requests/capability reports, and the ROs outside the subset may be used for one or more other UEs 104 that are not requesting PUCCH repetition or reporting their respective capabilities (e.g., 2-step RACH and/or 4-step RACH). Further, high layer signaling pucchRequestRepEnable described herein can indicate whether the UE 104 can request PUCCH repetition on the configured RO. For example, when pucchRequestRepEnable is enabled, the UE 104 can determine, based on this indication (e.g., enabling indication), that the currently configured ROs can be requested with 2-step RACH and/or PUCCH repetition using the corresponding ROs in the PRACH mask index. In this case, according to the mask index, the UE 104 can determine one or more additional ROs in which to send at least one message for a 2-step random access procedure, for example. When pucchRequestRepEnable is disabled, the pucchRequestRepEnable can indicate that the currently configured ROs may not be used to request PUCCH repetition. Instead, the currently configured ROs can be used for 2-step RACH and/or 4-step RACH. An example mapping relationship (e.g., association) between at least the PRACH mask index and the (e.g., currently) configured ROs can be provided in Table 2. In various cases, the higher layer can indicate the relationship between the PUCCH repetition number and ROs via/through the configuration of Table 2.

| PRACH Mask | | |
|---|---|---|
| Index/pucchRequestRep- | | |
| SSB-SharedRO-MaskIndex | Allowed RO(s) for MsgA | Allowed RO(s) for PUCCH |
| 1 | RO 1 | RO ∈ some of {2, 3, 4} or |
| | | RO ∈ some of {2, 3, 4, 5, 6, 7, 8} |
| 2 | RO 2 | RO ∈ some of {1, 3, 4} or |
| | | RO ∈ some of {1, 3, 4, 5, 6, 7, 8} |
| 3 | RO 3 | RO ∈ some of {1, 2, 4} or |
| | | RO ∈ some of {1, 2, 4, 5, 6, 7, 8} |
| 4 | RO 4 | RO ∈ some of {1, 2, 3} or |
| | | RO ∈ some of {1, 2, 3, 5, 6, 7, 8} |
| 5 | RO 5 | RO ∈ some of {1, 2, 3, 4, 6, 7, 8} |
| 6 | RO 6 | RO ∈ some of {1, 2, 3, 4, 5, 7, 8} |
| 7 | RO 7 | RO ∈ some of {1, 2, 3, 4, 5, 6, 8} |
| 8 | RO 8 | RO ∈ some of {1, 2, 3, 4, 5, 6, 7} |
| 9 | Every even RO# | $RO ∈ \{ {C}_{every even or odd RO}^{remaining RO} \}$ |
| 10 | Every odd RO# | $RO ∈ \{ {C}_{every even or odd RO}^{remaining RO} \}$ |
| 11~15 | Reserved | Reserved |

In some implementations, for ssb-perRACH-OccasionAndCB-PreamblesPerSSB = 1/4, some ROs may be associated with or represent up to two of the three values in the set, and at least one of the three values in the set. For ssb-perRACH-OccasionAndCB-PreamblesPerSSB = 1/8, some ROs may represent up to six of the seven values in the set, and at least one of the seven values in the set.

### Example Table 2 PRACH Mask Index Values for PUCCH Request

### Example 2a of Example Implementation 3

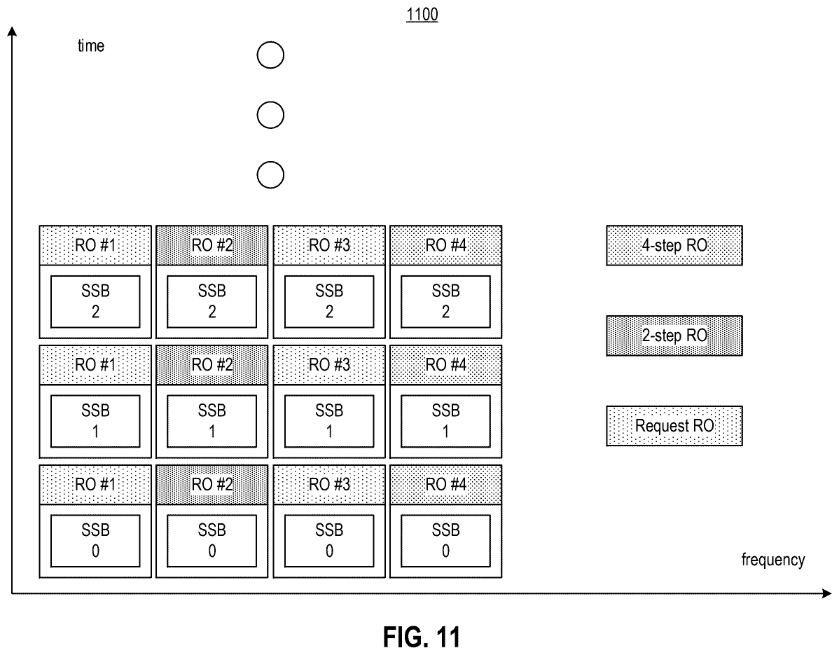

Referring to FIG. 11, depicted is another example 1100 of the first RO allocation pattern with a PRACH mask index of two (e.g., using the example Table 2), in accordance with some embodiments of the present disclosure. In some implementations, when pucchRequestRepEnable=1, PRACH mask index=2, ssb-perRACH-OccasionAndCB-PreamlesPerSSB=¼ (e.g., less than ½), and msg1-FDM=4, the high layer signaling can indicate that an SSB is associated with four ROs (e.g., frequency domain) (or each SSB can be mapped to at least three ROs), for example. Each time domain RO can include or have four frequency domain ROs. For example, the four frequency domain ROs on the first time domain RO correspond to one SSB, the four frequency domain ROs on the second time domain RO correspond to the other SSB, etc. In such configurations, the RO used for 2-step RACH can be the second frequency domain RO in each time domain (e.g., RO #2 in this case). Additionally or alternatively, the RO used for PUCCH repetition can include or correspond to at least or a combination of the first frequency domain RO (e.g., RO #1), the third frequency domain RO (e.g., RO #3), and/or the fourth frequency domain RO (e.g., RO #4), among others. In this example, the requested RO can correspond to the fourth frequency domain RO, although the requested RO may correspond to other frequency domain ROs. The example mapping relationship of the ROs and the SSBs can be shown in FIG. 11, for example.

### Example 2b of Example Implementation 3

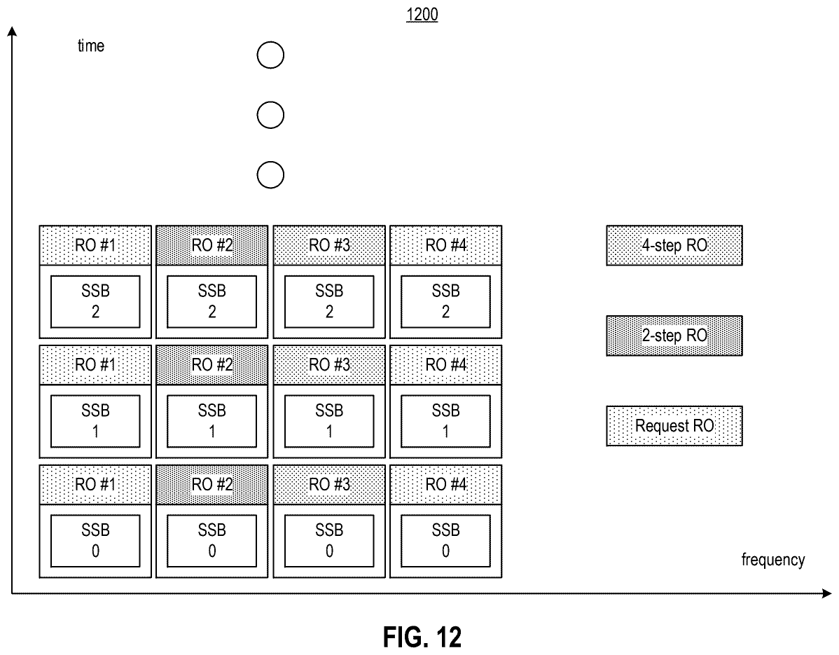

Referring to FIG. 12, depicted is another example 1200 of the second RO allocation pattern with a PRACH mask index of two, in accordance with some embodiments of the present disclosure. In some implementations, when pucchRequestRepEnable=1, PRACH mask index=2, ssb-perRACH-OccasionAndCB-PreamlesPerSSB=¼, msg1-FDM=4, the high layer signaling can indicate that an SSB is associated with four ROs (e.g., frequency domain). Each time domain RO can include four frequency domain ROs. The four frequency domain ROs on the first time domain RO can correspond to a first SSB, the four frequency domain ROs on the second time domain RO correspond to a second SSB, etc. In such configurations, the RO used for 2-step RACH can be the second frequency domain RO in each time domain (e.g., RO #2). Additionally or alternatively, the RO used for PUCCH replication can be at least one or a combination of the first frequency domain RO, the third frequency domain RO, and/or the fourth frequency domain RO. In this example, the selected ROs can include the first and fourth frequency domain ROs (e.g., RO #1 and RO #4). The example mapping relationship of the ROs and the SSBs can be shown in FIG. 12, for example.

### Example 2c of Example Implementation 3

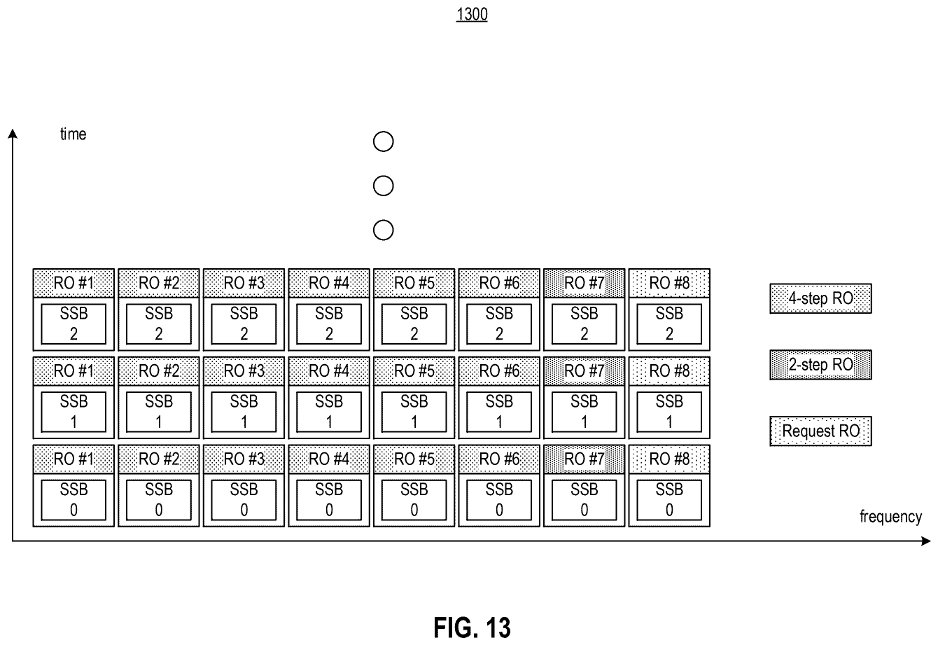

Referring to FIG. 13, depicted is an example 1300 of the first RO allocation pattern with a PRACH mask index of seven, in accordance with some embodiments of the present disclosure. In some implementations, when pucchRequestRepEnable=1, PRACH mask index=7, ssb-perRACH-OccasionAndCB-PreamlesPerSSB=⅛, msg1-FDM=8, the high layer signaling can indicate that an SSB is associated with 8 ROs (e.g., frequency domain). In this case, there may be 8 frequency domain ROs on a respective time domain RO. The 8 frequency domain ROs on the first time domain RO can correspond to a first SSB, the 8 frequency domain ROs on the second time domain RO correspond to a second SSB, etc. In such configurations, the RO used for 2-step RACH may be the seventh frequency domain RO (e.g., RO #7) in each time domain. Additionally or alternatively, the RO used for PUCCH repetition can be at least one or a combination of at least two of the first frequency domain RO to the sixth frequency domain RO (e.g., RO #1-6), and/or the eighth frequency domain RO (e.g., RO #8). In this example, the requested RO can be RO #8. In this case, the mapping relationship between the ROs and the SSBs can be shown in FIG. 13, for example.

### Example 2d of Example Implementation 3

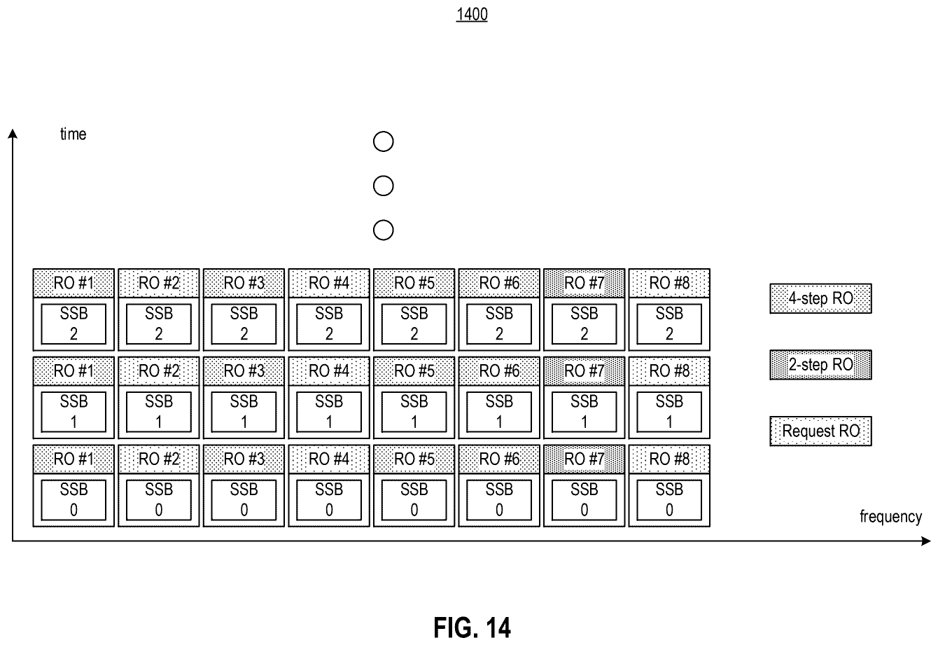

Referring to FIG. 14, depicted is an example 1400 of an RO allocation pattern with a PRACH mask index of seven, in accordance with some embodiments of the present disclosure. In some implementations, when pucchRequestRepEnable=1, PRACH mask index=7, ssb-perRACH-OccasionAndCB-PreamlesPerSSB=⅛, msg1-FDM=8, the high layer signaling can indicate that an SSB is associated with 8 ROs (e.g., frequency domain). There may be 8 frequency domain ROs on a respective time domain RO. The 8 frequency domain ROs on the first time domain RO can correspond to a first SSB, the 8 frequency domain ROs on the second time domain RO can correspond to a second SSB, etc. In such configurations, the RO used for 2-step RACH may be the seventh frequency domain RO (e.g., RO #7) in each time domain. Additionally or alternatively, the ROs used for PUCCH replication and/or 4-step RO can be at least one or a combination of at least two of the first frequency domain RO to the sixth frequency domain RO (e.g., RO #1-6), and/or the eighth frequency domain RO (e.g., RO #8). In this example, the requested ROs can be the second RO (e.g., RO #2), the fourth RO (e.g., RO #4), and/or the eighth RO (e.g. RO #8). The example mapping relationship can be shown in FIG. 14, for example.

### Example 2e of Example Implementation 3

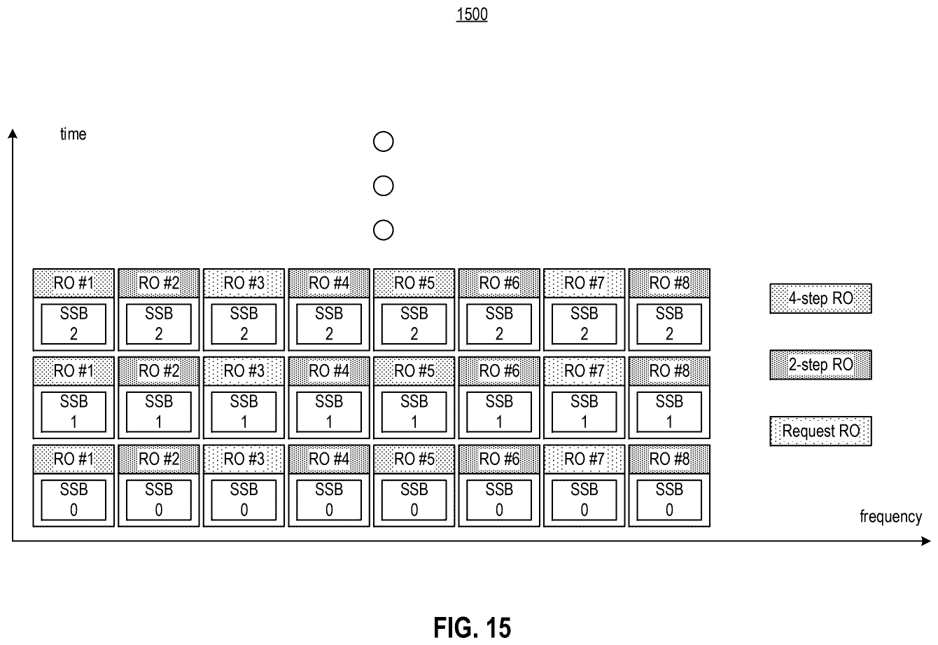

Referring to FIG. 15, depicted is an example 1500 of an RO allocation pattern with a PRACH mask index of nine, in accordance with some embodiments of the present disclosure. In some implementations, when pucchRequestRepEnable=1, PRACH mask index=9, ssb-perRACH-OccasionAndCB-PreamlesPerSSB=⅛, and msg1-FDM=8, the high layer signaling can indicate that an SSB is associated with 8 ROs (e.g., frequency domain). In this case, there may be 8 frequency domain ROs on a respective time domain RO. The 8 frequency domain ROs on the first time domain RO can correspond to a first SSB, the 8 frequency domain ROs on the second time domain RO can correspond to a second SSB, etc. In such configurations, the RO used for 2-step RACH can be selected or configured as even frequency domain ROs in each time domain (e.g., RO #2, RO #4, RO #6, and/or RO #8 in each time domain). Additionally or alternatively, the requested RO used for PUCCH repetition and/or for 4-step RO can be the first frequency domain RO (e.g., RO #1), the third frequency domain RO (e.g., RO #3), the fifth frequency domain RO (e.g., RO #5), and/or the seventh frequency domain RO (e.g., RO #7) (e.g., odd-numbered frequency domain ROs). The corresponding implicit frequency domain index can include or correspond to the first to fourth frequency domain ROs (e.g., RO #1-4). In this example, the requested RO may be the even frequency domain RO in the remaining ROs. For example, the third frequency domain RO and the seventh frequency domain RO corresponding to the second frequency domain RO and the fourth frequency domain RO (e.g., RO #2 and RO #4) can be used to request PUCCH repetition. The example mapping relationship can be shown in FIG. 15, for example.

### Example 3 of Example Implementation 3

In various implementations, a high layer signaling pucchRequestRep-SSB-SharedRO-MaskIndex (e.g., PRACH mask index) can be defined/configured for indexing ROs (e.g., currently) available for PUCCH repetition. The mask index can occupy 6 bits, indicating the subset of a subset of 4-step type ROs shared with requesting PUCCH repetition for each SSB. The same allowed/enabled ROs for msgA may correspond to different ROs for PUCCH repetition indexed by different PRACH mask indexes. This field of high layer signaling can be configured when there are more than two ROs per (e.g., associated with each) SSB.

In some cases, if the pucchRequestRepEnable is absent (e.g., does not exist or not presented), the 4-step and 2-step may have shared ROs. If the pucchRequestRepEnable, in this case, partial RO sharing can be supported. The ROs within the subset can be shared with PUCCH for repetition requests/capability reports. The ROs outside the subset can be used for one or more other UEs 104 that are not requesting PUCCH repetition, such as for 2-step RACH and/or 4-step RACH. Further, high layer signaling pucchRequestRepEnable can indicate whether the UE 104 can or is allowed to request PUCCH repetition on the configured RO. For example, when pucchRequestRepEnable is enabled/activated, the pucchRequestRepEnable can indicate that the (e.g., currently) configured ROs can be requested with 2-step RACH and/or PUCCH repetition using the corresponding ROs in the PRACH mask index. When pucchRequestRepEnable is disabled/inactive, the pucchRequestRepEnable can indicate that the configured ROs may not be used to request PUCCH repetition. Instead, in this case, the configured ROs may be used for 2-step RACH and/or 4-step RACH. The higher layer can indicate the relationship between PUCCH repetition number and ROs via the example configuration of Table 3, for example.

| PRACH Mask Index/ | | |
|---|---|---|
| pucchRequestRep-SSB- | Allowed RO(s) | |
| SharedRO-MaskIndex | for MsgA | Allowed RO(s) for PUCCH |
| 1 | RO 1 | RO 2 |
| 2 | RO 1 | RO 3 |
| 3 | RO 1 | RO 4 |
| 4 | RO1 | RO 5 |
| 5 | RO 2 | RO 6 |
| 6 | RO 2 | RO 7 |
| 7 | RO 2 | RO 8 |
| 8 | RO 2 | RO 3 |
| 9 | RO 3 | RO 4 |
| 10 | RO 3 | RO 5 |
| 11 | RO 3 | RO 6 |
| 12 | RO 3 | RO 7 |
| 13 | RO 4 | RO 8 |
| 14 | RO 4 | RO 1 |
| 15 | RO 4 | RO 2 |
| 16 | RO 4 | RO 3 |
| 17 | RO 5 | RO 4 |
| 18 | RO 5 | RO 6 |
| 19 | RO 5 | RO 7 |
| 20 | RO 5 | RO 8 |
| 21 | RO 6 | RO 1 |
| 22 | RO 6 | RO 2 |
| 23 | RO 6 | RO 3 |
| 24 | RO 6 | RO 4 |
| 25 | RO 7 | RO 5 |
| 26 | RO 7 | RO 6 |
| 27 | RO 7 | RO 8 |
| 28 | RO 7 | RO 1 |
| 29 | RO 8 | RO 2 |
| 30 | RO 8 | RO 3 |
| 31 | RO 8 | RO 4 |
| 32 | RO 8 | RO 5 |
| 33 | Every even RO | $RO ∈ \{ {C}_{every even or odd RO}^{remaining RO} \}$ |
| 34 | Every odd RO | $RO ∈ \{ {C}_{every even or odd RO}^{remaining RO} \}$ |
| 35~64 | Reserved | Reserved |

### Example Table 3: PRACH Mask Index Values for PUCCH Request

### Example Implementation 4: PUCCH Repetition Request/Capability Report Via Msg3

In certain implementations, regarding request/capability indication in msg3 PUSCH, certain systems may convey the information via a logical channel identifier (LCID) field and/or in the medium access control (MAC) subheader field of msg3 (e.g., two reserved bits of the MAC subheader field). For example, the UE 104 can send the message for PUCCH repetition to the BS 102 via the msg3. The UE 104 can send the message to the BS 102 via LCID field or MAC subheader field of the msg3. Because the UE 104 may not perform PUCCH repetition in certain situations, additional criteria/conditions/restrictions can be introduced herein to determine whether to use at least one bit in the msg3 MAC subheader to request repetition or report capability.

In various implementations, the UE 104 can send the message to the BS 102 for PUCCH repetition via the msg3 when at least one condition is satisfied/met. The condition (e.g., implicit condition) can include at least one of the following:
1) Multiple repetition numbers may be configured by SIB signaling. If the multiple repetition numbers are configured by SIB signaling, the bit field in the msg3 MAC subheader can be interpreted by default (e.g., implicitly) to request repetition. For example, if 1 bit is reused in the MAC subheader of msg3, a value of ‘1’ can indicate that the UE 104 is requesting PUCCH repetition, and a value of ‘0’ can indicate that the UE 104 is not requesting the transmission repetition (e.g., no repetition is requested).
2) A measured reference signal received power (RSRP) may be lower than a predetermined/configured threshold. If the RSRP threshold is configured and the measured RSRP is lower/less than or below the RSRP threshold, the bit field in the msg3 MAC subheader can be interpreted by default to request repetition. For example, if 1 bit is reused in the MAC subheader of msg3, a value of ‘1’ can indicate that the UE 104 is requesting PUCCH repetition, and a value of ‘0’ can indicate that no repetition is requested by/from the UE 104.

In some cases, the condition may be explicit for indicating whether the UE 104 is requesting the repetition or reporting the capability. In this case, the condition may be used additionally or together with the high layer signaling. For example, the explicit condition can include at least one of the following:
3) pucchRequestRepEnable can be configured to determine whether to use a certain bit in the msg3 MAC subheader to request repetition. For example, if pucchRequestRepEnable is enabled (e.g., the pucchRequestRepEnable is being utilized), and if 1 bit is reused in the MAC subheader of msg3, a value of 1 (e.g., bit is set to ‘1’) can indicate that the UE 104 is requesting PUCCH repetition. Otherwise, a value of ‘0’ can indicate that no repetition is requested. If pucchRequestRepEnable is disabled, the UE 104 may not be able to (e.g., not allowed to) request repetition using the MAC subheader of msg3, for example.

### Example Implementation 5: Implicitly Indicates Repetition Number Via ROs

In various configurations, the UE 104 may use the RO(s) configured by the BS 102 (or network) to request repetition/report capability for PUCCH. The different ROs can correspond to or be used to indicate (e.g., represent) a specific or respective repetition number configured by SIB signaling. In such cases, the UE 104 can be configured to determine a repetition number for the PUCCH repetition (e.g., capability report), according to at least one of: the mask index, and/or the one or more available ROs in which to send the message for PUCCH repetition. For example, the BS 102 can (e.g., implicitly) indicate the repetition number for PUCCH msg4 HARQ-ACK via at least one of the following example techniques/methods/procedures.

### Example 1a of Example Implementation 5

In some configurations, a subset defined/configured in multiple ROs corresponding to each SSB can be used to share repetition requests/capability reports to PUCCH. The different ROs corresponding to each PRACH mask index can be mapped to specific replication (e.g., repetition) numbers. For example, when PRACH mask index=3, the associated PRACH occasion index 3 can be used to request PUCCH repetition. The ‘specific value 3’ can indicate or represent the repetition number of PUCCH. The ‘specific value 3’ can be the third repetition number configured by the BS 102, e.g., 4. The higher layer can indicate the relationship between the PUCCH repetition number and the requested ROs via the configuration indicated in example Table 4 (e.g., associated with example Table 1).

| PRACH Mask | | Specific |
|---|---|---|
| Index/pucchRequestRep- | Allowed PRACH | Repetition |
| SSB-SharedRO-MaskIndex | occasion(s) of SSB | number |
| 0 | Reserved | Reserved |
| 1 | RO 1 | Specific value1 |
| 2 | RO 2 | Specific value2 |
| 3 | RO 3 | Specific value3 |
| 4 | RO 4 | Specific value1 |
| 5 | RO 5 | Specific value2 |
| 6 | RO 6 | Specific value3 |
| 7 | RO 7 | Specific value1 |
| 8 | RO 8 | Specific value2 |
| 9 | Every even RO | Specific value3 |
| 10 | Every odd RO | Specific value3 |
| 11-15 | Reserved | Reserved |

### Example Table 4: PRACH Mask Index Values for PUCCH Request and Repetition Number

### Example 1b of Example Implementation 5

In some configurations, the subset (e.g., one or more) of a subset defined in multiple ROs corresponding to each SSB may be used to share repetition requests/capability reports to PUCCH. One or more ROs corresponding to each PRACH mask index may be mapped to specific or associated repetition numbers. For example, when PRACH Mask Index=3, ROs can be associated with or a part of (e.g., belong to) {1, 2, 4} and/or {1, 2, 4, 5, 6, 7, 8} can be used to request PUCCH repetition. In this example, the ‘specific value 3’ can indicate the repetition number of PUCCH. The ‘specific value 3’ can be the third repetition number configured by the BS 102, e.g., 4. The BS 102 can indicate the relationship between PUCCH repetition number and the requested ROs via the configuration example Table 5 (e.g., associated with or corresponding to example Table 2).

| PRACH Mask | | | |
|---|---|---|---|
| Index/pucchRequestRep- | | | Specific |
| SSB-SharedRO- | Allowed RO(s) | Allowed RO(s) for | Repetition |
| MaskIndex | for MsgA | PUCCH | number |
| 1 | RO 1 | RO ∈ some of {2, 3, 4} or | Specific value1 |
| | | RO ∈ some of {2, 3, 4, 5, 6, 7, 8} | |
| 2 | RO 2 | RO ∈ some of {1, 3, 4} or | Specific value2 |
| | | RO ∈ some of {1, 3, 4, 5, 6, 7, 8} | |
| 3 | RO 3 | RO ∈ some of {1, 2, 4} or | Specific value3 |
| | | RO ∈ some of {1, 2, 4, 5, 6, 7, 8} | |
| 4 | RO 4 | RO ∈ some of {1, 2, 3} or | Specific value1 |
| | | RO ∈ some of {1, 2, 3, 5, 6, 7, 8} | |
| 5 | RO 5 | RO ∈ some of {1, 2, 3, 4, 6, 7, 8} | Specific value2 |
| 6 | RO 6 | RO ∈ some of {1, 2, 3, 4, 5, 7, 8} | Specific value3 |
| 7 | RO 7 | RO ∈ some of {1, 2, 3, 4, 5, 6, 8} | Specific value1 |
| 8 | RO 8 | RO ∈ some of {1, 2, 3, 4, 5, 6, 7} | Specific value2 |
| 9 | Every even RO | $RO ∈ \{ {C}_{every even or odd RO}^{remaining RO} \}$ | Specific value3 |
| 10 | Every odd RO | $RO ∈ \{ {C}_{every even or odd RO}^{remaining RO} \}$ | Specific value3 |
| 11~15 | Reserved | Reserved | Reserved |

For ssb-perRACH-OccasionAndCB-PreamblesPerSSB = 1/4, some ROs may represent up to two of the three values in the set, and at least one of the three values in the set. For ssb-perRACH-OccasionAndCB-PreamblesPerSSB = 1/8, some ROs may represent up to six of the seven values in the set, and at least one of the seven values in the set.

### Example Table 5 PRACH Mask Index Values for PUCCH Request and Repetition Number

### Example 1c of Example Implementation 5

In some configurations, a subset of a subset defined in multiple ROs corresponding to each SSB may be used to share repetition requests/capability reports to PUCCH. In this case, multiple ROs corresponding to each PRACH mask index can be mapped to or associated with multiple specific repetition numbers. For example, when PRACH mask index=3, one or more ROs can be associated with or a part of {1, 2, 4} and/or {1, 2, 4, 5, 6, 7, 8} can be used to request the PUCCH repetition. Different numbers of ROs can correspond to different repetition numbers. For instance, ‘specific value 1’ corresponding to a single RO can indicate the first repetition number configured by the BS 102, ‘specific value 2’ corresponding to two ROs can indicate two repetition numbers configured by the BS 102, where the first RO can indicate the first repetition number configured by the BS 102, and the second RO can indicate the second repetition number configured by the BS 102, etc. The high layer signaling can indicate the relationship between PUCCH repetition number and requested ROs via the configuration of/from example Table 6 (e.g., associated with or corresponding to example Table 2).

| PRACH Mask | | | |
|---|---|---|---|
| Index/pucchRequestRep- | | | Specific |
| SSB-SharedRO- | Allowed RO(s) | Allowed RO(s) for | Repetition |
| MaskIndex | for MsgA | PUCCH | number |
| 1 | RO 1 | RO ∈ some of {2, 3, 4} or | Specific value(1 |
| | | RO ∈ some of {2, 3, 4, 5, 6, 7, 8} | to N_{ROs}) |
| 2 | RO 2 | RO ∈ some of {1, 3, 4} or | Specific value(1 |
| | | RO ∈ some of {1, 3, 4, 5, 6, 7, 8} | to N_{ROs}) |
| 3 | RO 3 | RO ∈ some of {1, 2, 4} or | Specific value(1 |
| | | RO ∈ some of {1, 2, 4, 5, 6, 7, 8} | to N_{ROs}) |
| 4 | RO 4 | RO ∈ some of {1, 2, 3} or | Specific value(1 |
| | | RO ∈ some of {1, 2, 3, 5, 6, 7, 8} | to N_{ROs}) |
| 5 | RO 5 | RO ∈ some of {1, 2, 3, 4, 6, 7, 8} | Specific value(1 |
| | | | to N_{ROs}) |
| 6 | RO 6 | RO ∈ some of {1, 2, 3, 4, 5, 7, 8} | Specific value(1 |
| | | | to N_{ROs}) |
| 7 | RO 7 | RO ∈ some of {1, 2, 3, 4, 5, 6, 8} | Specific value(1 |
| | | | to N_{ROs}) |
| 8 | RO 8 | RO ∈ some of {1, 2, 3, 4, 5, 6, 7} | Specific value(1 |
| | | | to N_{ROs}) |
| 9 | Every even RO | $RO ∈ \{ {C}_{every even or odd RO}^{remaining RO} \}$ | Specific value(1 to N_{ROs}) |
| 10 | Every odd RO | $RO ∈ \{ {C}_{every even or odd RO}^{remaining RO} \}$ | Specific value(1 to N_{ROs}) |
| 11 | Reserved | Reserved | Reserved |

In some cases, for ssb-perRACH-OccasionAndCB-PreamblesPerSSB = 1/4, some ROs can represent up to two of the three values in the set, and at least one of the three values in the set. For ssb-perRACH-OccasionAndCB-PreamblesPerSSB = 1/8, some ROs can represent up to six of the seven values in the set, and at least one of the seven values in the set. The NROs can represent the number of selected ROs.

### Example Table 6 PRACH Mask Index Values for PUCCH Request and Repetition Number

### Example 1d of Example Implementation 5

In some configurations, a high layer signaling pucchRequestRep-SSB-SharedRO-MaskIndex (e.g., PRACH mask index) can be defined for indexing ROs (e.g., currently) available for PUCCH repetition. The mask index may occupy 6 bits, indicating the subset of a subset of 4-step type ROs shared with requesting PUCCH repetition for each SSB. The same allowed RO for msgA may correspond to different ROs for PUCCH repetition indexed by different PRACH mask indexes, for example. This field of the high layer signaling can be configured when there are more than two ROs per respective SSB.

In some case, if the pucchRequestRepEnable is absent (e.g., not included), only 4-step and/or 2-step can have shared ROs. If the pucchRequestRepEnable is present, in this case, for example, when PRACH mask index=3, RO #4 (e.g., the fourth RO, such as the frequency domain RO) can be used to request PUCCH repetition. In this case, the ‘specific value 3’ can indicate the repetition number of PUCCH, and/or the ‘specific value 3’ can be the third repetition number configured by the BS 102, e.g., 4. The high layer signaling can indicate the relationship between PUCCH repetition number and ROs via the configuration from example Table 7, among other tables (e.g., associated with example Table 3).

| PRACH Mask | | | |
|---|---|---|---|
| Index/ | | | |
| pucchRequestRep- | Allowed | | Specific |
| SSB-SharedRO- | RO(s) | Allowed RO(s) for | Repetition |
| MaskIndex | for MsgA | PUCCH | number |
| 1 | RO 1 | RO 2 | Specific value1 |
| 2 | RO 1 | RO 3 | Specific value2 |
| 3 | RO 1 | RO 4 | Specific value3 |
| 4 | RO 1 | RO 5 | Specific value1 |
| 5 | RO 2 | RO 6 | Specific value2 |
| 6 | RO 2 | RO 7 | Specific value3 |
| 7 | RO 2 | RO 8 | Specific value1 |
| 8 | RO 2 | RO 3 | Specific value2 |
| 9 | RO 3 | RO 4 | Specific value3 |
| 10 | RO 3 | RO 5 | Specific value1 |
| 11 | RO 3 | RO 6 | Specific value2 |
| 12 | RO 3 | RO 7 | Specific value3 |
| 13 | RO 4 | RO 8 | Specific value1 |
| 14 | RO 4 | RO 1 | Specific value2 |
| 15 | RO 4 | RO 2 | Specific value3 |
| 16 | RO 4 | RO 3 | Specific value1 |
| 17 | RO 5 | RO 4 | Specific value2 |
| 18 | RO 5 | RO 6 | Specific value3 |
| 19 | RO 5 | RO 7 | Specific value1 |
| 20 | RO 5 | RO 8 | Specific value2 |
| 21 | RO 6 | RO 1 | Specific value3 |
| 22 | RO 6 | RO 2 | Specific value1 |
| 23 | RO 6 | RO 3 | Specific value2 |
| 24 | RO 6 | RO 4 | Specific value3 |
| 25 | RO 7 | RO 5 | Specific value1 |
| 26 | RO 7 | RO 6 | Specific value2 |
| 27 | RO 7 | RO 8 | Specific value3 |
| 28 | RO 7 | RO 1 | Specific value1 |
| 29 | RO 8 | RO 2 | Specific value2 |
| 30 | RO 8 | RO 3 | Specific value3 |
| 31 | RO 8 | RO 4 | Specific value1 |
| 32 | RO 8 | RO 5 | Specific value2 |
| 33 | Every even RO | $RO ∈ \{ {C}_{every even or odd RO}^{remaining RO} \}$ | Specific value3 |
| 34 | Every odd RO | $RO ∈ \{ {C}_{every even or odd RO}^{remaining RO} \}$ | Specific value1 |
| 35~64 | Reserved | Reserved | Reserved |

### Example Table 7 PRACH Mask Index Values for PUCCH Request

### Example Implementation 6: Indicates Repetition Number Via Dynamic Indication

In various implementations, the BS 102 (e.g., or network) can use DCI scheduling msg4 to indicate the repetition number. In this case, the UE 104 can determine the repetition number for the PUCCH repetition, according to the indication in DCI scheduling msg4 PDSCH (e.g., second indication including the bits of DCI in a PDCCH portion of msg4). The msg4 can include a PDCCH portion (e.g., including DCI). The DCI scheduling msg4 can be used with the high layer enabled signal if configured explicitly, for example.

In scenarios where a certain bit field (e.g., modular and coding scheme (MCS) bit field, downlink assist index (DAI) field, etc.) in DCI scheduling msg4 may be used to indicate the repetition number, to avoid conflict regarding whether such bit field is being used to indicate the repetition number, the pucchRequestRepEnable can be configured to indicate whether to enable the indication of DCI, such as discussed herein. For instance, the BS 102 can indicate the repetition number for PUCCH msg4 HARQ-ACK explicitly via at least one of the following example configurations.

### Example 1 of Example Implementation 6

In some configurations, 2-bit of the existing bit field in DCI scheduling msg4 can be reused to indicate the repetition number. The UE 104 can determine the repetition number for the PUCCH repetition according to the indication (e.g., second indication) in the DCI scheduling msg4 PDSCH when at least one condition is satisfied/met. The condition may include the UE 104 receiving an indication (e.g., first indication) indicating that the UE 104 is allowed to interpret the second indication in DCI scheduling msg4 PDSCH for PUCCH repetition. For example, if pucchRequestRepEnable is enabled (e.g., received the first indication), the UE 104 can perform repetition with the repetition number determined by interpreting/reidentifying the existing bit field of DCI. If the pucchRequestRepEnable is disabled, the UE 104 may not perform repetition regardless of whether the repetition number is configured.

### Example 2 of Example Implementation 6

In some configurations, a 2-bit field may be added/included/provided in the DCI scheduling msg4 to indicate the repetition number. For example, when pucchRequestRepEnable is enabled, the UE 104 can perform the repetition with the repetition number determined by the additional/newly defined 2-bit field of the DCI. Otherwise, if the pucchRequestRepEnable is disabled, the UE 104 may not perform the repetition regardless of whether the repetition number is configured. In some cases, the BS 102 may implicitly indicate the repetition number of PUCCH for msg4 HARQ-ACK via at least one of the following example configurations (e.g., examples 3-5 of at least the example implementation 6), discussed herein.

### Example 3 of Example Implementation 6

In some configurations, if multiple repetition numbers are configured by/via the SIB signaling, the UE 104 can interpret the DCI bit field (e.g., by default) to indicate the number of repetitions. In this case, the UE 104 can determine the repetition number for the PUCCH repetition responsive to or when multiple repetition numbers are configured by SIB signaling, as the condition or a part of the condition. Subsequently, the UE 104 can perform the repetition with a repetition number determined by interpreting the existing bit field of DCI.

### Example 4 of Example Implementation 6

In some configurations, if an RSRP threshold is configured and the measured RSRP is lower/less than the configured threshold (e.g., RSRP threshold), the DCI bit field can be interpreted by default to indicate the number of repetitions. The measured RSRP being lower than the RSRP threshold can be the condition for the UE 104 to determine the repetition number for PUCCH repetition. The UE 104 can perform the repetition with the repetition number determined by interpreting the existing bit field of DCI, for example.

### Example 5 of Example Implementation 6

In some configurations, if the message (e.g., a request for PUCCH repetition, and/or a capability report for PUCCH repetition) for PUCCH repetition is sent by the UE 104 (e.g., wireless communication device), the DCI bit field can be interpreted by default to indicate the number of repetitions. The measured RSRP can be the condition (or a part of the condition) for the UE 104 to determine the repetition number for PUCCH repetition. The UE 104 can perform the repetition with the repetition number determined by interpreting the existing bit field of DCI, for example.

### Example Implementation 7: Frequency Hopping Indication

In certain systems, PUCCH for msg4 HARQ-ACK may not perform repetition(s). When useInterlacePUCCH-PUSCH is configured by BWP-UplinkCommon, the UE 104 may not perform intra-slot frequency hopping. Otherwise, (e.g., when useInterlacePUCCH-PUSCH is not configured) the UE 104 can perform intra-slot frequency hopping. In various implementations, the UE 104 can determine, according to an indication (e.g., bits of DCI scheduling msg4 PDSCH) and/or a higher layer signaling, at least one of whether to perform frequency hopping for the PUCCH repetition, and/or a type of frequency hopping to perform for the PUCCH repetition. For example, when PUCCH for msg4 HARQ-ACK is configured to perform the repetition, the frequency hopping type can be configured (e.g., explicitly) via at least one of the following example configurations/procedures.

### Example 1 of Example Implementation 7

In some configurations, 1-bit of the existing bit field in DCI scheduling msg4 can be reused or configured to indicate whether to perform intra-slot frequency hopping for the PUCCH repetition (e.g., or when performing repetition). For example, if the value (of the 1-bit of the bit field in DCI) is 1, the UE 104 can determine to perform intra-slot frequency hopping. If the value is 0 or the bit field is not present, the UE 104 may perform inter-slot frequency hopping per slot and/or perform inter-slot frequency hopping per interval of consecutive slots for PUCCH DMRS-bundling.

### Example 2 of Example Implementation 7

In some configurations, a 1-bit frequency hopping indicator can be added/included/provided in DCI scheduling msg4 to indicate whether to perform intra-slot frequency hopping when performing repetition. For example, if the value of the 1-bit frequency hopping indicator is 1, the UE 104 can perform intra-slot frequency hopping. If the value of the 1-bit frequency hopping indicator is 0 (or the bit field is not present), the UE 104 may perform inter-slot frequency hopping per slot and/or perform inter-slot frequency hopping per interval of consecutive slots for PUCCH DMRS-bundling.

### Example 3 of Example Implementation 7

In some configurations, a 1-bit frequency hopping indicator in high layer signaling, such as PUCCH-configCommon, can be added/included to indicate whether to perform intra-slot frequency hopping when performing repetition. For example, if the value of the 1-bit frequency hopping indicator in the high layer signaling is 1, the UE 104 can perform intra-slot frequency hopping. Otherwise, if the value of the 1-bit frequency hopping indicator in the high layer signaling is 0 (or the bit field is not present), the UE 104 may perform inter-slot frequency hopping per slot and/or perform inter-slot frequency hopping per interval of consecutive slots for PUCCH DMRS-bundling.

### Example 4 of Example Implementation 7

In some configurations, a 1-bit frequency hopping indicator in higher layer signaling, such as PUCCH-configCommon, can be added to indicate whether to perform inter-slot frequency hopping when performing repetition. For example, if the value of the 1-bit frequency hopping indicator in the high layer signaling is 1, the UE 104 may not perform the inter-slot frequency hopping. Instead, the UE 104 may (e.g., only) perform intra-slot frequency hopping. If the value of the 1-bit frequency hopping indicator in the high layer signaling is 0 (or the bit field is not present), the UE 104 may perform inter-slot frequency hopping per slot and/or perform inter-slot frequency hopping per interval of consecutive slots for PUCCH DMRS-bundling.

In some other cases, an implicit indication associated with (e.g., coupling along with) the indicated repetition number can also be considered for PUCCH to determine whether to perform frequency hopping. In this case, the UE 104 may determine or select at least one of the following: whether to perform frequency hopping for the PUCCH repetition, and/or a type (e.g., intra-slot or inter-slot frequency hopping) of frequency hopping to perform for the PUCCH repetition, according to at least one of: whether a repetition number is indicated via a DCI scheduling msg4 PDSCH; whether a bit field to indicate frequency hopping pattern is indicated via SIB signaling; and/or whether PUCCH repetition is configured to perform DMRS bundling among repetitions.

### Example 5 of Example Implementation 7

In some configurations, if the repetition number is not indicated via DCI scheduling msg4, the UE 104 may not perform any type of frequency hopping (e.g., including inter-slot and intra-slot).

### Example 6 of Example Implementation 7

In some configurations, if the repetition number is indicated via DCI scheduling msg4, the UE 104 may perform intra-slot frequency hopping by default, such as responsive to receiving the indication from the BS 102.

### Example 7 of Example Implementation 7

In some configurations, if the repetition number is indicated via DCI scheduling msg4, and PUCCH for msg4 HARQ-ACK is not configured to perform DMRS-bundling among repetitions, the UE 104 may be configured to perform inter-slot frequency hopping per slot.

### Example 8 of Example Implementation 7

In some configurations, if the repetition number is indicated via DCI scheduling msg4, and PUCCH for msg4 HARQ-ACK is configured to perform DMRS-bundling among repetitions, the UE 104 may be configured to perform inter-slot frequency hopping per interval of consecutive slots for PUCCH DMRS-bundling.

### Example 9 of Example Implementation 7

In some configurations, a bit field can be defined/configured/provided to indicate the length per hopping. The bit field can be broadcasted by the BS 102 via SIB signaling. The bit field can occupy 2 bits (e.g., among other numbers of bits), for instance, representing that per hop can occupy a maximum of 4 slots and a minimum of 1 slot. For example, if the repetition number is indicated via DCI scheduling msg4 and the bit field value is ‘01’ (e.g., corresponding to 2 slots), the UE 104 may perform inter-slot frequency hopping per 2 slots.

In various arrangements, the coverage enhancement schemes/approaches for PUCCH repetition in the NTN as discussed herein can be applied to or used for RRCSetupComplete (e.g., msg5) repetition enhancement. The RRCSetupComplete (e.g., msg5) repetition enhancement can reuse one or more of the contents, approaches, strategies, or configurations of PUCCH repetition. For example, when requesting a PUCCH repetition, the RRCSetupComplete repetition may be requested. The PUCCH repetition number indication, validity duration, etc., can be extended to the RRCSetupComplete. In some cases, some new segments may be defined in a similar manner. The multi-bit indication in msg3 (e.g., in cases of 2 bits, where a first bit can be for requesting PUCCH repeats, and another bit can be for requesting RRCSetupComplete repeats) can request RRCSetupComplete repetitions. Similarly, adding or reusing other bits to indicate the number of duplicates/replications or repetitions, among other enhancement techniques can be expanded/extended/applied in a similar manner to various other configurations, scenarios, or procedures. In some cases, the repetition number used for PUCCH can be reused for the PUSCH carrying RRCSetupComplete (e.g., msg5 in random access procedure).

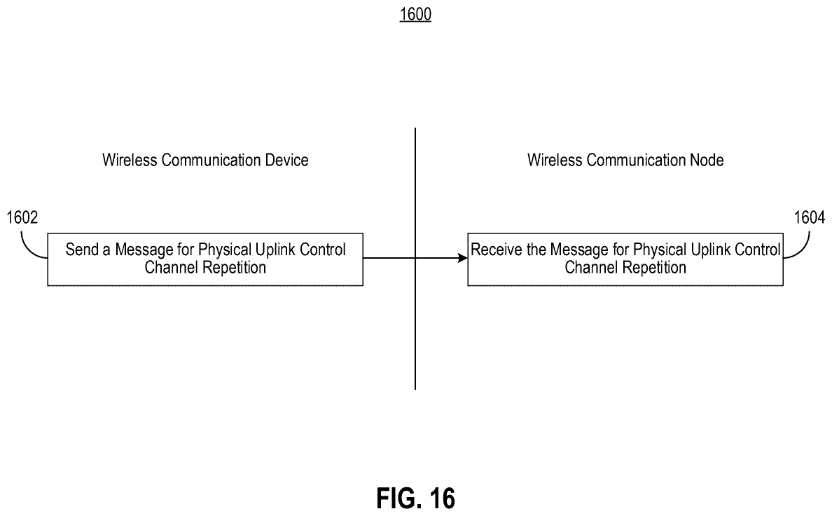

FIG. 16 illustrates a flow diagram of an example method 1600 for coverage enhancement in NTN. The method 1600 may be implemented using any one or more of the components and devices detailed herein in conjunction with FIGS. 1-15. In brief overview, the method 1600 may be performed by at least one wireless communication device (e.g., a UE), at least one wireless communication node (e.g., a BS, gNB, or access network equipment), at least one satellite, etc., in some embodiments. Additional, fewer, or different operations may be performed in the method 1600 depending on the embodiment. At least one aspect of the operations can be directed to a system, method, apparatus, or a computer-readable medium.

At operation 1602, a wireless communication device can send/transmit/communicate/signal/provide a message for physical uplink control channel (PUCCH) repetition to a wireless communication node. At operation 1604, the wireless communication node can receive/obtain/acquire the message for PUCCH repetition from the wireless communication device. The PUCCH repetition can comprise repetition of at least one of: PUCCH for msg4 hybrid automatic repeat request acknowledgment (HARQ-ACK), and/or common PUCCH (e.g., as opposed to or instead of dedicated PUCCH). The message can comprise at least one of: a request for PUCCH repetition (e.g., request for repetition, request for repetition with recommended value from the wireless communication device, request for repetition by following the indicated value if a single value is indicated by the wireless communication node, request for repetition according to the indication via DCI, where the indication via the DCI may refer to the dedicated bit or existing bit-field to scheduling msg2 and/or msg4 PDSCH, in some cases), and/or a capability report for PUCCH repetition (e.g., the capability may refer to the capability to support PUCCH repetition, capability of the number of repetition for PUCCH repetition, capability of supporting the dynamic indicated repetition number, in some examples, the dynamic indicated repetition number can refer to the indication via the DCI). The PUCCH types may include two specified types. For example, a first type can include PUCCH for Msg4 HARQ-ACK and/or common PUCCH. A second type can include dedicated PUCCH. The enhancements (e.g., support for PUCCH repetition) to the RACH process can be enhancements to at least the first type of PUCCH, for example.

In various implementations, the wireless communication device can receive a system information block (SIB) signaling from the wireless communication node. The SIB signaling can include a first indication (e.g., pucchRequestRepEnable) of at least one of: whether the wireless communication device is allowed/enabled to send the message for PUCCH repetition, and/or whether the wireless communication device is allowed to interpret a second indication in downlink control information (DCI) scheduling msg4 physical downlink shared channel (PDSCH) for PUCCH repetition. The msg4 can include or have a PDCCH portion that can have DCI. In various implementations discussed herein, the alternative to the DCI scheduling ms4 PDSCH can include at least one of DCI signaling, msg4, and/or DCI signaling for scheduling msg4 PDSCH, etc. In some examples, the indication of the DCI can refer to the dedicated bit-field and/or existing bit-field (e.g., RV, MCS, etc.) to indicate the information (e.g., number of allowed repetition number, duration of application, among other information) for PUCCH repetition.

In some implementations, the message can include a preamble of/in msg1. The preamble can include at least one of: a first portion of the preamble to indicate msg3 repetition and PUCCH repetition; a second portion of the preamble to indicate msg3 repetition without PUCCH repetition; and/or a third portion of the preamble to indicate operation without msg3 repetition and PUCCH repetition. The portions can represent or correspond to fragments of the preamble. In some implementations, the wireless communication device may send the message for PUCCH repetition to the wireless communication node via a preamble, such as when at least one condition is satisfied/met. The condition can include at least one of: multiple repetition numbers are configured by system information block (SIB) signaling, a measured reference signal received power (RSRP) is lower/less than a configured threshold (e.g., RSRP threshold), and/or the first indication indicates that the wireless communication device is allowed to send the message for PUCCH repetition. For example, the configured threshold can include or correspond to a threshold configured by SIB. In some examples, the threshold may be dedicated for PUCCH repetition. In some other examples, the configured threshold for msg3 repetition, msg1 selection, and/or msg1 repetition can be reused. In yet some other examples, one factor as delta value (or scaling factor) may be configured and the threshold may be jointly determined by the configured factor and/or the threshold for msg3 repetion, msg1 selection, and/or msg1 repetition.

In some arrangements, the wireless communication device may receive a high layer signaling from the wireless communication node. The high layer signaling can include a mask index. The high layer signaling may include or correspond to SIB signaling, RRC signaling MAC CE signaling, etc. The wireless communication device can determine/identify, according to the mask index, one or more available random access channel (RACH) occasions (ROs) in which to send the message for PUCCH repetition, for example. In some configurations, each synchronization signal block (SSB) may be associated with at least two ROs. In this case, the first indication (e.g., pucchRequestRepEnable) can indicate that the wireless communication device is allowed to send the message for PUCCH repetition.

In some configurations, the wireless communication device can determine, according to the mask index, one or more other ROs in which to send at least one message for a 4-step random access procedure. In some cases, the wireless communication device may determine, according to the mask index, one or more additional ROs in which to send at least one message for a 2-step random access procedure.

In various configurations, the wireless communication device can send the message for PUCCH repetition to the wireless communication node via msg3. In such cases, the wireless communication device may send the message for PUCCH repetition via a logical channel identifier (LCID) field or a medium access control (MAC) subheader field of the msg3 to the wireless communication node. In some implementations, the wireless communication device may send the message for PUCCH repetition to the wireless communication node via the msg3, when at least one condition is satisfied. For example, the condition can include at least one of: multiple repetition numbers are configured by SIB signaling, a measured RSRP is lower than a configured threshold, and/or receiving the first indication (e.g., pucchRequestRepEnable) indicating that the wireless communication device is allowed to send the message for PUCCH repetition.

In some implementations, the wireless communication device can determine/identify a repetition number for the PUCCH repetition according to at least one of: the mask index, and/or the one or more available ROs in which to send the message for PUCCH repetition. In some implementations, the wireless communication device can determine a repetition number for the PUCCH repetition, according to the second indication (e.g., bits of DCI in a PDCCH portion of msg4) in DCI scheduling msg4 PDSCH. For example, the msg4 may include or have a PDCCH portion (e.g., that may have DCI). Additionally or alternatively to DCI scheduling msg4 PDSCH, the second indication may be provided in or included as a part of the msg4, or DCI signaling for scheduling msg4 PDSCH.

In some implementations, the wireless communication device may determine the repetition number for the PUCCH repetition, according to the second indication (e.g., bits of DCI in a PDCCH portion of msg4) in DCI scheduling msg4 PDSCH, when at least one condition is satisfied. In this case, the condition can include at least one of: the wireless communication device received a first indication (e.g., pucchRequestRepEnable) indicating that the wireless communication device is allowed to interpret the second indication in DCI scheduling msg4 PDSCH for PUCCH repetition, multiple repetition numbers are configured by/via SIB signaling, the message for PUCCH repetition is sent by the wireless communication device, and/or a measured RSRP is lower than a configured threshold.

In some implementations, the wireless communication device may determine, according to a third indication (e.g., bits of DCI in a PDCCH portion of msg4 and/or in DCI scheduling msg4 PDSCH) in DCI scheduling msg4 PDSCH or a higher layer signaling, at least one of: whether to perform frequency hopping for the PUCCH repetition, and/or a type of frequency hopping to perform for the PUCCH repetition. The type of frequency hopping can include at least one of intra-slot frequency hopping and/or inter-slot frequency hopping.

In various configurations, the wireless communication device may determine at least one of: whether to perform frequency hopping for the PUCCH repetition, and/or a type of frequency hopping (e.g., intra-slot frequency hopping and/or inter-slot frequency hopping) to perform for the PUCCH repetition. The wireless communication device may perform the determination according to at least one of: whether a repetition number is indicated via a DCI scheduling msg4 PDSCH; whether a bit field to indicate frequency hopping pattern is indicated via SIB signaling; and/or whether PUCCH repetition is configured to perform demodulation reference signal (DMRS) bundling among the repetitions.

In some configurations, the wireless communication device can determine a duration of application of PUCCH repetition (e.g., validity duration), where PUCCH repetition can be applied/performed (or is enabled) during this duration, such as in response (or according) to the request/capability report. For example, the wireless communication device can determine the duration of application according to one of the following: a duration that starts at a time of sending of the message, and ends at a time at which the wireless communication device receives a configuration for a dedicated PUCCH from the wireless communication node; a duration that starts at a time of sending the message for PUCCH repetition, and ends at a time at which the wireless communication device sends a next message for PUCCH repetition; a duration that starts at a time of sending of the message for PUCCH repetition and ends at a time at which the wireless communication device receives another second indication of an updated repetition number, in DCI scheduling msg4 PDSCH, from the wireless communication node; a duration that starts at a time of receiving the second indication in DCI scheduling msg4 PDSCH, and ends at a time at which the wireless communication device receives a configuration for a dedicated PUCCH from the wireless communication node; a duration that starts at a time of receiving the second indication in DCI scheduling msg4 PDSCH, and ends at a time at which the wireless communication device sends a next message for PUCCH repetition; or a duration that starts at a time of receiving the second indication in DCI scheduling msg4 PDSCH, and ends at a time at which the wireless communication device receives the another second indication of an updated repetition number, in DCI scheduling msg4 PDSCH, from the wireless communication node.

In some implementations, the repetition number of PUCCH carrying HARQ-ACK for msg4 may be used for various PUCCH determined by common PUCCH resource configuration. In some implementations, the repetition number may be used until (or up to) the determination of a new repetition value (e.g., indicated by the wireless communication node and/or determined by wireless communication device).

In some cases, to determine the duration of application, the wireless communication device may receive/obtain a SIB signaling or a fourth indication (e.g., indicating the validity duration) in DCI scheduling msg4 PDSCH from the wireless communication node. The signaling (e.g., SIB signaling or the fourth indication) can include at least one of: a specific (e.g. predefined) value of the duration of validity; and/or an index corresponding to the specific value of the duration of validity.

In some cases, the wireless communication device can start/initiate/trigger a timer for the duration of application, such as responsive to the sending of the message for PUCCH repetition. In some other cases, the wireless communication device may start the timer for the duration of application, responsive to receiving the second indication (e.g., the indication of repetition number) in DCI scheduling msg4 PDSCH.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
sending, by a wireless communication device to a wireless communication node via a msg3, a capability report for physical uplink control channel (PUCCH) repetition,
wherein the PUCCH repetition comprises repetition of PUCCH for msg4 hybrid automatic repeat request acknowledgment (HARQ-ACK).

2. The method of claim 1, comprising:
sending, by the wireless communication device to the wireless communication node, the capability report for PUCCH repetition via a logical channel identifier (LCID) field or a medium access control (MAC) subheader field of the msg3.

3. The method of claim 1, comprising:
sending, by the wireless communication device to the wireless communication node, the capability report for PUCCH repetition via the msg3, when following condition is satisfied:
multiple repetition numbers are configured by system information block (SIB) signaling, and
a measured reference signal received power (RSRP) is lower than a configured threshold.

4. The method of claim 1, comprising:
determining, by the wireless communication device, a repetition number for the PUCCH repetition, according to a downlink assist index (DAI) field in downlink control information (DCI) scheduling msg4 physical downlink shared channel (PDSCH).

5. The method of claim 4, comprising:
determining, by the wireless communication device, the repetition number for the PUCCH repetition, according to the DAI field when a condition is satisfied, wherein the condition comprises at least one of:
multiple repetition numbers are configured by system information block (SIB) signaling,
the capability report for PUCCH repetition is sent by the wireless communication device, or
a measured reference signal received power (RSRP) is lower than a configured threshold.

6. The method of claim 1, comprising:
determining, by the wireless communication device, whether to perform frequency hopping for the PUCCH repetition, according to whether useInterlacePUCCH-PUSCH is configured in BWP-UplinkCommon.

7. The method of claim 6, wherein the frequency hopping comprises intra-slot frequency hopping.

8. A method comprising:
receiving, by a wireless communication node from a wireless communication device via a msg3, a capability report for physical uplink control channel (PUCCH) repetition,
wherein the PUCCH repetition comprises repetition of PUCCH for msg4 hybrid automatic repeat request acknowledgment (HARQ-ACK).

9. The method of claim 8, comprising:
receiving, by wireless communication node from the wireless communication device, the capability report for PUCCH repetition via a logical channel identifier (LCID) field or a medium access control (MAC) subheader field of the msg3.

10. The method of claim 8, comprising:
receiving, by the wireless communication node from the wireless communication device, the capability report for PUCCH repetition via the msg3, when following condition is satisfied:
multiple repetition numbers are configured by system information block (SIB) signaling, and
a measured reference signal received power (RSRP) is lower than a configured threshold.

11. The method of claim 8, wherein a repetition number for the PUCCH repetition is determined according to a downlink assist index (DAI) field in downlink control information (DCI) scheduling msg4 physical downlink shared channel (PDSCH).

12. The method of claim 11, wherein the repetition number for the PUCCH repetition is determined according to the DAI field when a condition is satisfied, wherein the condition comprises at least one of:
multiple repetition numbers are configured by system information block (SIB) signaling,
the capability report for PUCCH repetition is sent by the wireless communication device, or
a measured reference signal received power (RSRP) is lower than a configured threshold.

13. The method of claim 8, wherein whether to perform frequency hopping for the PUCCH repetition, is determined according to whether useInterlacePUCCH-PUSCH is configured in BWP-UplinkCommon.

14. The method of claim 13, wherein the frequency hopping comprises intra-slot frequency hopping.

15. A wireless communication device, comprising:
at least one processor configured to:
send, via a transmitter to a wireless communication node via a msg3, a capability report for physical uplink control channel (PUCCH) repetition,
wherein the PUCCH repetition comprises repetition of PUCCH for msg4 hybrid automatic repeat request acknowledgment (HARQ-ACK).

16. The wireless communication device of claim 15, wherein the at least one processor is configured to:
send, via the transmitter to the wireless communication node, the capability report for PUCCH repetition via a logical channel identifier (LCID) field or a medium access control (MAC) subheader field of the msg3.

17. The wireless communication device of claim 15, wherein the at least one processor is configured to:
send, via the transmitter to the wireless communication node, the capability report for PUCCH repetition via the msg3, when following condition is satisfied:
multiple repetition numbers are configured by system information block (SIB) signaling, and
a measured reference signal received power (RSRP) is lower than a configured threshold.

18. The wireless communication device of claim 15, wherein a repetition number for the PUCCH repetition is determined according to a downlink assist index (DAI) field in downlink control information (DCI) scheduling msg4 physical downlink shared channel (PDSCH).

19. The wireless communication device of claim 18, wherein the repetition number for the PUCCH repetition is determined according to the DAI field when a condition is satisfied, wherein the condition comprises at least one of:
multiple repetition numbers are configured by system information block (SIB) signaling,
the capability report for PUCCH repetition is sent by the wireless communication device, or
a measured reference signal received power (RSRP) is lower than a configured threshold.

20. A wireless communication node, comprising:
at least one processor configured to:
receive, via a receiver from a wireless communication device via a msg3, a capability report for physical uplink control channel (PUCCH) repetition,
wherein the PUCCH repetition comprises repetition of PUCCH for msg4 hybrid automatic repeat request acknowledgment (HARQ-ACK).
